(19) United States
(12) Patent Application Publication
(10) Pub. No.: US 2025/0066228 A1
(43) Pub. Date: Feb. 27, 2025

(54) ENHANCED SYSTEM AND METHOD FOR REMOVAL OF PFAS FROM AQUEOUS MATERIALS

(71) Applicants: Randall Moore, Powell, TN (US); Kevin Jackson, Knoxville, TN (US); Mark A. Litman, Edina, MN (US)

(72) Inventors: Randall Moore, Powell, TN (US); Kevin Jackson, Knoxville, TN (US); Mark A. Litman, Edina, MN (US)

(21) Appl. No.: 18/946,238

(22) Filed: Nov. 13, 2024

Related U.S. Application Data
(63) Continuation-in-part of application No. 17/237,040, filed on Apr. 21, 2021.
Application No. 17/237,040 is a continuation-in-part of application No. 17/087,728, filed on Nov. 3, 2020, now Pat. No. 12,172,909.

(51) Int. Cl. C02F 1/469; C02F 101/36

(52) U.S. Cl. CPC C02F 1/4695; C02F 2101/36; C02F 2201/46

(57) ABSTRACT

A system and method for the removal of poly- and/or perfluoroalkyl fluorinated materials contaminants from an aqueous mass uses a system which includes:
a) a first chamber for holding the aqueous mass containing a detectable amount of poly- and/or perfluoroalkyl fluorinated materials;
b) an anode and a cathode in electronic connection with the aqueous mass in the first chamber; and
c) an anionic semipermeable membrane or porous structure between the aqueous mass and the anode.

The anionic semipermeable membrane comprises at least 0.0001% by total weight of the anionic semipermeable membrane of a cationic compound adhered to the anionic semipermeable membrane.

### RELATED APPLICATIONS DATA

This application claims priority under 37 C.F.R. 1.120 as continuation-in-part of a Continuation-in-Part of U.S. patent application Ser. No. 17/237,040, filed 21 Apr. 2021 and titled “APPARATUS AND METHOD FOR MEDIATION OF PFAS CONTAMINATION IN AN ENVIRONMENT which in turn is a Continuation-in-Part of U.S. patent application Ser. No. 17/087,728, filed 3 Nov. 2020 and titled “APPARATUS AND METHOD FOR MEDIATION OF PFAS CONTAMINATION IN AN ENVIRONMENT.” Those Applications are incorporated herein in their entirety by reference.

### SUMMARY OF THE INVENTION

The current technology advance includes a system and method of using that system for the removal of poly- and/or perfluoroalkyl fluorinated (also referred to as highly-fluorinated alkyl) materials as contaminants from an aqueous mass. The system may generally include:
a. a first chamber for holding the aqueous mass containing a detectable amount of poly- and/or perfluoroalkyl fluorinated materials;
b. an anode and a cathode in electronic connection with the aqueous mass in the first chamber; and
c. an anionic poly- and/or perfluoroalkyl fluorinated material attractant and/or a semipermeable membrane or porous attracting or binding support for the poly- and/or perfluoroalkyl fluorinated material attractant between the aqueous mass and the anode.

### BRIEF DESCRIPTION OF THE FIGURES

FIG. 1 is a schematic of a cross-section of an AEC of the present technology.

FIG. 2 is a graphic representation of Total Current Required for PFOA Removal—Activity I.

FIG. 3 is a graphic representation of Total Current Required for PFOA Removal Activity I.

FIG. 4 is a graphic representation of Total Current Transfer Required to Achieve Fractional Salt Removal—Activity I.

FIG. 5 is a graphic representation of Total Current Transfer Required to Achieve Salt Mass Removal—Activity.

FIG. 6 is a graphic representation of Total PFOA and PFOS Removal as a Function of Salt Removal—Activity I.

FIG. 7 is a graphic representation of Total Current Required for PFOA Removal at 10 ppb Feed.

FIG. 8 is a graphic representation of Total Current Required for PFOA Removal at 10 ppb Feed.

FIG. 9 is a graphic representation of Total Current Required for PFOA and PFOS Removal at 10 ppb Feed.

FIG. 10 is a graphic representation of Total Current Required for PFOA Removal at 2 ppb Feed.

FIG. 11 is a graphic representation of Total Current Required for PFOS Removal at 2 ppb Feed.

FIG. 12 is a graphic representation of Total PFOA and PFOS Removal Versus Total Current at 2 and 10 ppb Feed.

FIG. 13 is a graphic representation of Total Current Required Total PFOS and PFOS Removal at 2 ppb Feed.

FIG. 14 is a graphic representation of Total Current Required to Achieve Salt Removal.

FIG. 15 is a graphic representation of Total PFOA and PFOS Removal Versus Salt Removal (20 ppb Total PFOA and PFOS).

FIG. 16 is a graphic representation of Total PFOA and PFOS Removal Versus Salt Removal (4 ppb Total PFOA and PFOS).

FIG. 17 is a graphic representation of Total Required Energy Per Mass PFAS Removal as a Function of Total PFAS Removal.

FIG. 18 is a graphic representation of AEC Operating Energy as a Function of Total Current.

FIG. 19 is a graphic representation of Activity I Average Run Cell Resistance as a Function of Average Feed Conductivity.

FIG. 20 is a graphic representation of Activity I Average Run Cell Resistance as a Function of Average Feed Conductivity.

FIG. 21 is a graphic representation of Activity I Average Run Cell Resistance as a Function of Average Feed Conductivity.

FIG. 22 is a graphic representation of Salt Removal Versus Total Power—Activity I.

FIG. 23 is a graphic representation of Effect of Electrode Spacing on AEC Module Resistance.

FIG. 24 is a graphic representation of Impact of AEM Final Conductivity on AEC Module Average Electrical Resistance—Activity I.

FIG. 25 is a graphic representation of Impact of Total Current on AEM and CEM Chamber Conductivity.

FIG. 26 is a graphic representation of Comparison of Total Current Requirement of Test 2-5 and 2-9.

FIG. 27 is a graphic representation of Comparison of FKS-50® membrane and Nafion® 117 membrane CEM Performance.

FIG. 28 is a graphic representation of Energy and Voltage as a Function of Feed Residence Time.

FIG. 29 is a graphic representation of Effect of Temperature on Salt Removal.

FIG. 30 is a graphic representation of Effect of Temperature on Total PFOA and PFOS Removal.

FIG. 31 is a graphic representation of Power Costs Based on Salt Rejection—Batch Testing.

FIG. 32 is a graphic representation of Power Costs Based on PFAS Removal—Flow Through Testing.

FIG. 33 is a graphic representation of Power Costs Based on PFAS Removal—Flow Through Testing.

FIG. 34 is a graphic representation of Power Costs Based on PFAS Removal—Flow Through Testing.

### DETAILED DESCRIPTION OF THE INVENTION

The current technology advance includes a system and method of using that system for the removal of poly- and/or perfluoroalkyl fluorinated (also referred to as highly-fluorinated alkyl) materials as contaminants from an aqueous mass. The system may generally include:
a. a first chamber for holding the aqueous mass containing a detectable amount of poly- and/or perfluoroalkyl fluorinated materials;
b. an anode and a cathode in electronic connection with the aqueous mass in the first chamber; and
c. an anionic poly- and/or perfluoroalkyl fluorinated material attractant and/or a semipermeable membrane or porous support for the poly- and/or perfluoroalkyl fluorinated material attractant between the aqueous mass and the anode.

The anionic semipermeable membrane includes at least 0.0005% by total weight of the anionic semipermeable membrane of a cationic compound adhered to the anionic semipermeable membrane (also described as an “ASM”). The adherence of the cationic material to the ASM may be as an adhered coating, a bonded (direct or with intermediate priming layer or surface) coating, a continuous coating, a discontinuous coating, sputter deposited layer, embedded particulate layer (continuous or discontinuous), and intermeshed fibrous materials.

The system typically will have a relatively stable (that is not necessarily chemically reactive within the system) second aqueous mass adjacent the anode and adjacent the anionic semipermeable membrane. A thin layer of water (with or without any other solubles) is sufficient at the surface of the electrode (against the electrode) and wetting/penetrating the semipermeable membrane. This second (or later third) aqueous mass acts to complete the biasing circuit between the anode and cathode across the intermediate volumes and layers.

The system may have the cationic material as a compound (including salts, blends, films, polymers, discontinuous coatings, etc.) having a cation preferably selected from the group consisting of quaternary ammonium cations, sulfonium cations, phosphonium cations, iodonium cations, and boronium cations. Other cationic materials may be used, but these are the most common and simplest to use in the practice of the present invention.

The system also may have the cationic material present as at least 0.0005% or at least 0.001% by total weight of the anionic semipermeable membrane or porous support (of course, measured as not including the weight of the cationic material) of a cationic compound adhered to the anionic semipermeable membrane or porous support.

The systems of this technology are most easily constructed wherein the cationic material comprises a polymer. The preferred polymers, because of their broad commercial availability and well-known properties system are quaternary ammonium polymers. The system is functional when the anionic semipermeable membrane has a thickness between 30 μm and 900 μm. (As later described, the porous support may be or may have to thicker, such as from 50 μm or 2 mm or more). Thinner membranes tend to be too fragile, although functional, and thicker membranes offer no further improvement, as much of the adherence of the PFAS takes place in the upper portions of the membrane (towards the first chamber), and seldom much beyond 400 μm. (As the porous materials are thicker, with generally larger pores and a greater flow rate through them, there tends to be more internal adsorption of PFAS).

The systems may also use the anionic semipermeable membrane with a thickness between 100 and 700 μm. The system may also use a cationic semipermeable membrane between the contaminated aqueous mass and the cathode. The system may also include a cationic semipermeable membrane between the aqueous mass and the cathode, and further wherein there is a third aqueous mass adjacent the cathode and adjacent the cathodic semipermeable membrane. The cationic semipermeable membrane also may have a thickness between 30 and 900 μm.

The systems may use a spacer (as further described herein) within the first chamber to prevent the anodic semipermeable membrane and the cationic semipermeable membrane from collapsing into the first chamber.

A new aspect of the present technology is the discovery of the use of added amounts, discontinuous coatings and even continuous coatings of cationic materials, particularly cationic polymers or cationic coatings on and/or in the anionic semipermeable membrane (hereinafter, “ASM”). The addition of these cationic materials has been found to increase the strength of retention of anionic PFAS materials on and in the ASM. Amounts as small as at least 0.0005% by weight of cationic materials in the ASM material produce measurable increases in PFAS retention. The only limit on higher amounts of cationic materials is avoiding such clogging of the pores that PFAS cannot move under the biasing current into the pores. Depending on pore frequency and size and total volume, the weight range of cationic materials may be from 0.0005%-10% by weight of the ASM total weight (not including cationic materials). More typically, the range will be from 0.001% to 5%, 0.001 to 3%, 0.005% to 3%, or 0.075% to 2%. Any cationic compound/polymer may be used if the cationic material if at least 50% of the cationic material adheres to the ASM for at least 10 hours in deionized water at 70° F. flowing at 1 cm/minute over the coated ASM surface. The pore size in ASMs can vary significantly depending upon the materials targeted for attraction. In osmosis systems and ultrafiltration systems, the pore size may be as small as 0.1 nm, so that is a minimum size for any range of ASMs in the practice of the present technology. More likely, where there are higher molecular weight PFAS (e.g., not only CF₄ or CF₃COOH size molecules), larger pore sizes, and larger minimum pore sizes are desirable, such as at least 2 nm, at least, 5 nm, at least 25 nm, at least 50 nm, at least 100 nm, and even at least 200 nm. (as background information, cf https://link.springer.com/chapter/10.1007/978-3-540-73994-4_5 as K. C. Khulbe, C. K. Feng, T. Matsura, Springer Laboratories, Synthetic Polymer Membranes, pp. 101-139). The largest pores sizes generally found are about 500 nm, 2000 nm (e.g., 2 μm), up to a top commercial system of about 10 μm, 20 μm, 50 μm or 100 μm (Khulbe, supra). The larger the pore size, there is likely greater throughput of contaminated liquids, but with an increasing possibility that some nano-size nonionic particles may pass entirely through the ASM. General ranges may be selected from within 1-1000 nm, 1-700 nm, 2-500 nm and the like, with any selected range using any of the above lowest pore sizes up to a combination with the largest pore sizes listed above.

The cationic materials useful as the additive to the ASMs is any solid-forming or solid material having a positive charge that can persist on the ASM in room temperature distilled water without more than 50% dissolving in light agitation for at least 10 hours. The most common materials used as the cationic additive (partial or continuous coating, particulate, fibrous, or deposited content on the ASM) are multimeric (at least dimeric, more typically polymeric) molecules having a definitive positive charge on a contained (within the multimeric material) positively charged group. These materials are most typically chains (including chains with ring groups) having dependent cationic groups such as quaternary amines, sulfonium groups, phosphonium groups, boronium groups, iodonium groups (and possibly other halonium groups) as known in the art. By having the positively charged groups as pendant groups, they tend to be more accessible to attract PFAS and retain them in an ionic bond.

Cationic polymers are a family of polymers that carry a positive charge due to the presence of cations, which are positively charged ions. This positive disposition makes them sociable with negatively charged substances, allowing them to form strong bonds.

### Chemical Structure and Properties

Cationic polymers are a family of polymers positively charged at certain pH levels (e.g., there are always some positively charges present, but the concentration/frequency of positive charges varies with the pH.

The chemical structure of these polymers includes a backbone with the attached quaternary groups. In this discussion, the most common cationic/positively charged group, called quaternary ammonium (or quaternary amine) groups will be generally discussed. As later evidenced herein, there are numerous alternative groups, not all of which have been specifically identified. These hold the positive charge that makes the polymer cationic.

This positive charge is what gives these polymers their general PFAS attractive ability. For instance, in water treatment, they act like attractants, clumping together unwanted molecules so that they can be more easily removed from the scene. They work efficiently and fast, making them ideal in situations where time is of the essence.

As quaternary (cationic) materials tend to have significant solubility in water, in the preferred practices of the present invention, they should form films to make them persistent as an active coating.

In essence, the chemical structure and properties of cationic polymers give them the ability to form strong bonds with oppositely charged materials, behave predictably in various environments, and to make them a valuable asset in both industrial and medical fields.

### Applications in Water Treatment

Cationic polymers attract negatively charged particles in water. If the cationic particles were added as an ingredient directly into contaminated water, their positive charge would pull in contaminants to form larger groups, known as flocs. These flocs would be easier to physically remove from water because they grow in size, becoming too large to stay dissolved in water.

In the water purification process, these cationic polymers would be added during the flocculation stage to speed up the process of clumping together suspended particles so that water becomes clearer faster.

The term “polymer” originates from two Greek words: “poly,” meaning “many,” and “meros,” which translates to “parts” or “units.” Each polymer is made up of many repeating units known as monomers, which are the building blocks that join to form these long and intricate chains. The nature of the monomers and the way they link together determines the characteristics of the resulting polymer.

### Synthesis

Polymers are formed by polymerization in which small molecules (monomers) react to link to form long chains.
Addition polymerization occurs when monomers add to each other without losing any atoms. Imagine a line of people holding hands, each person representing a monomer; as more people join hands, the chain gets longer.
Condensation polymerization involves the loss of small molecules such as water when monomers bond together.

These reactions can be controlled to tailor the polymer's properties, such as strength, solubility, ionic content, actives content or flexibility, making polymers. Initiators and catalysts often help kick-start and guide these polymerization processes, ensuring consistency and quality in the resulting polymer chains.

### Structure

Polymer chains are composed of repeating units formed from the monomers. The structure can be linear, with a straight sequence, branched, where side-chains are attached to the main chain, or cross-linked, where chains are interconnected forming a three-dimensional network. The arrangement of these monomers can be random, alternating, block, or graft, leading to different material characteristics. Molecular weight, the total mass of the monomers within a chain, also influences properties like strength and melting point. Understanding this intricate architecture helps engineers tailor polymers for specific construction tasks.

### Properties

Polymers exhibit a diverse array of characteristics due to the variations in their molecular makeup. Imagine a polymer chain as a train with many cars—the properties of the train change depending on the type of cars and their arrangement.
1. Strength and Durability: Longer polymer chains often result in materials with greater strength and durability. Strong intermolecular forces, such as those in nylon, lead to a sturdy and resistant material.
2. Flexibility: The flexibility of polymers like rubber is due to the long chains that can move around and adjust without breaking. This is likened to a series of interconnected springs that can stretch and rebound.
3. Thermal Properties: Polymers can be engineered to withstand high temperatures, as seen in heat-resistant plastics, or to melt at low temperatures, facilitating their molding and shaping.
4. Chemical Resistance: Some polymers are resistant to chemicals, making them ideal for containers and coatings. The specific arrangement of atoms in the chain provides defense against corrosive substances.
5. Insulation: Electrical insulation is a key trait for polymers used in electronics. Polymer chains do not conduct electricity, which makes them perfect for safeguarding electrical components.
6. Optical Properties: Certain polymers can be made transparent or tailored to filter specific wavelengths of light, much like a pair of sunglasses that filters out UV rays.

Understanding these properties is vital to selecting the appropriate polymer for a specific application in construction, ensuring materials perform as expected in different environments and uses. The following images exemplify cationic polymers (with the basic NH₂, or NR₄⁺ groups providing the positive charge) and anionic polymers (with acid groups such as SO₃⁻ and COO⁻) forming acid anionic moieties.

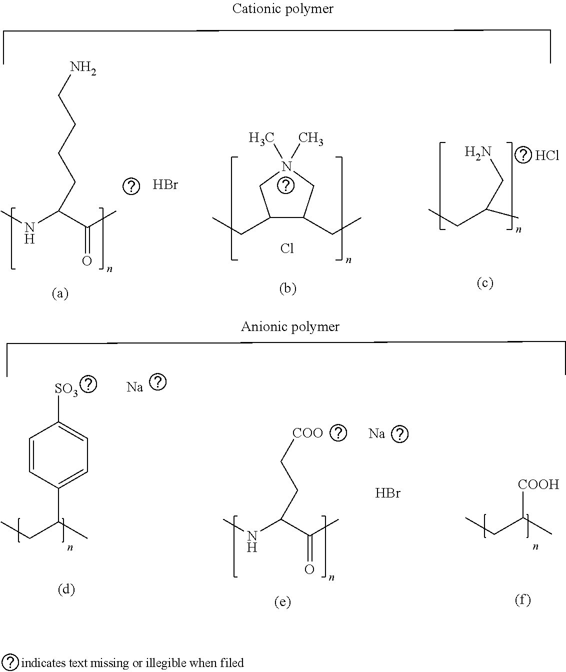

Examples of other cationic polymers are listed below.

SULFONIUM POLYMERS, CONTAINING S+R¹R²R³R⁴ groups (where R are hydrogen, linear or cyclic alkyl, alkylene, aryl, or other organic groups).

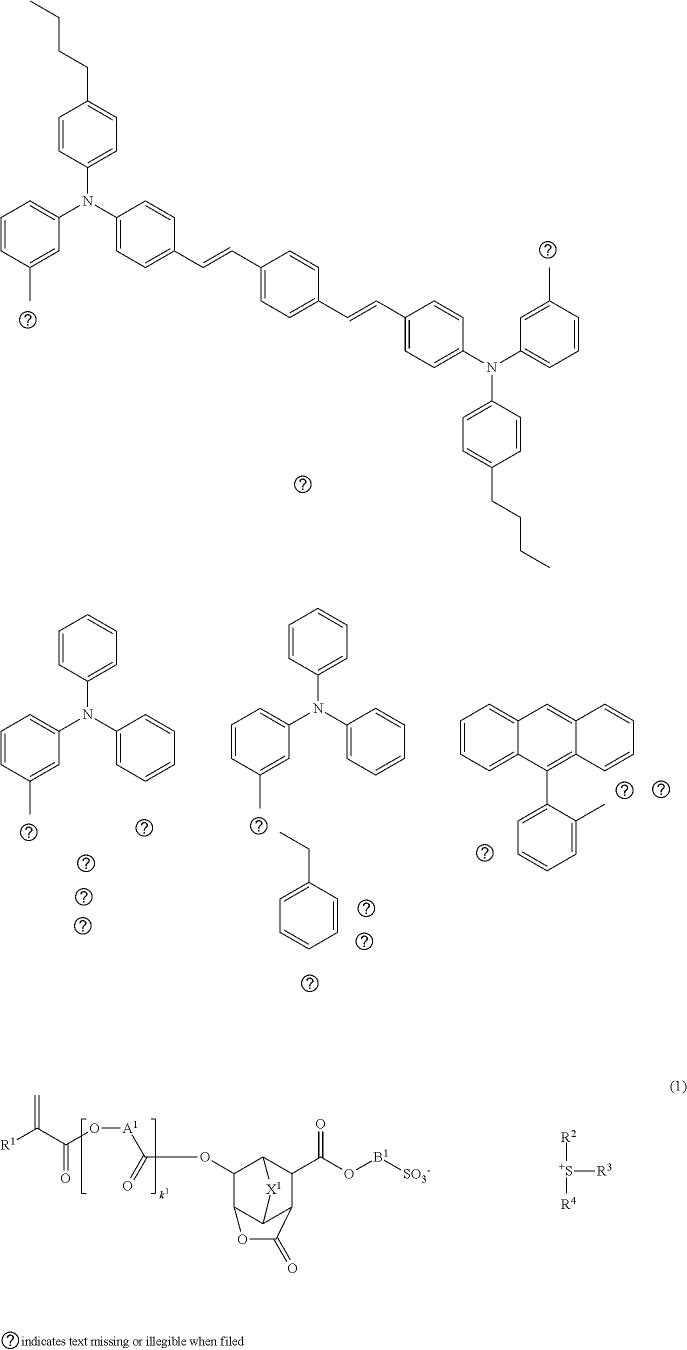

In chemistry, the term phosphonium (more obscurely: phosphinium) describes polyatomic cations with an exemplary chemical formula PR₄
(where R is a hydrogen or an alkyl, aryl or halide group). These cations have tetrahedral structures. The salts are generally colorless or take the color of the anions.

### Types of Phosphonium Cations

### Protonated Phosphines

The parent phosphonium is PH₄ as found in the iodide salt, phosphonium iodide. Salts of the parent PH₄ are rarely encountered, but this ion is an intermediate in the preparation of the industrially useful tetrakis (hydroxymethyl) phosphonium chloride:

PH₃+HCl+4CH₂O→P(CH₂OH)₄Cl⁻

Many organophosphonium salts are produced by protonation of primary, secondary and tertiary phosphines:

PR₃+H⁺→HPR⁺₃

The basicity of phosphines follows the usual trends, with R=alkyl being more basic than R=aryl.

### Tetraorganophosphonium Cations

The most common phosphonium compounds have four organic substituents attached to phosphorus. The quaternary phosphonium cations include tetraphenyl phosphonium. (C₆H₅)₄P⁺ and tetramethylphosphonium P(CH₃)⁺₄. All of these lower molecular cationic compounds alternatively may be dissolved in neutral or other cationic polymers, but this is not the preferred method as the cationic strength tends to be lower than with pendant cationic groups.

Quaternary phosphonium cations (PR⁺₄) are produced by alkylation of organophosphines. For example, the reaction of triphenylphosphine with methyl bromide yields methyltriphenylphosphonium bromide:

PPh₃+CH₃Br→[CH₃PPh₃]⁺Br⁻

### Textile Finishes

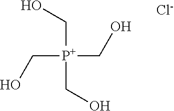

Tetrakis (hydroxymethyl) phosphonium chloride (THPC) is used in production of textiles, and has industrial importance in the production of crease-resistant and flame-retardant finishes on cotton textiles and other cellulosic fabrics. A flame-retardant finish can be prepared from THPC by the Proban Process, in which THPC is treated with urea. The urea condenses with the hydroxymethyl groups on THPC. The phosphonium structure is converted to phosphine oxide as the result of this reaction. (Weil, Edward D).; Levchik, Sergei V. (2008). “Flame Retardants in Commercial Use or Development for Textiles”. J. Fire Science 26 (3): 243-281. doi: 10.1177/0734904108089485. S2CID 98355305. And Svara, Jürgen; Weferling, Norbert; Hofmann, Thomas. Phosphorus Compounds, Organic. Ullmann's Encyclopedia of Industrial Chemistry. John Wiley & Sons, Inc., 2008 doi: 10.1002/14356007.a19_545.pub2; and Reeves, Wilson A.; Guthrie, John D. (1956). “Intermediate for Flame-Resistant Polymers-Reactions of Tetrakis (hydroxymethyl) phosphonium Chloride”. Industrial and Engineering Chemistry. 48 (1): 64-67. doi: 10.1021/ie50553a021.

### Organoboronium Amphiphilic Block Copolymers

December 2009; Journal of Polymer Science Part A Polymer Chemistry 47(23):6612-6618; 47(23):6612-6618; DOI: 10.1002/pola.23703.

Polyaminoboranes—https://pubs.acs.org/doi/pdf/10.1021/jacs.1c10888 JACS (Journal of the American Chemical Society) \Retraction for Journal of Materials Chemistry: Selective scission of pyridine-boronium complexes: mechanical generation of Brønsted bases and polymerization catalysts Kelly M. Wiggins, Todd W. Hudnall, Andrew G. Tennyson and Christopher W. Bielawski* J. Mater. Chem., 2011, 21, 8355-8359 (DOI: 10.1039/COJM03619F).

### Polymeric Iodonium Salts

In a significant breakthrough from classical molecular (i.e., nonpolymeric) iodonium salts in light-induced photochemistry, the synthesis and use of new safer polymeric iodonium salts are now known. They are shown to be involved in charge transfer complexes (CTCs) while in interaction with a safe amino acid derivative (N-phenylglycine). Also, this study demonstrates i) the formation of CTCs between the iodonium (acceptor) and an aryl/alkyl amine (donor) through UV—vis measurements of the monomer, ii) the formation of radicals in electron spin resonance spin trapping experiments when the CTCs are irradiated by visible light (405 nm), and iii) their efficiency as a photoinitiator to polymerize three different acrylic monomers under LED irradiation at 405 nm under air and their application to 3D resolved laser writing of thick samples (3 mm). High reactivity for polymeric iodonium salts comparable with molecular ones is exhibited with the advantage of potential lower migration. To the best of the authors' knowledge, this is the first reported instance of polymeric iodonium salts acting as polymerization initiators. This reference is background material on the availability of polymeric iodonium salts and has no other technical relationship to the present invention.

https://onlinelibrary.wiley.com/doi/abs/10.1002/marc.201900644

A method for extracting poly- and/or perfluoroalkyl fluorinated materials from an aqueous medium includes:
providing an aqueous medium contaminated with measurable levels of poly- and/or perfluoroalkyl fluorinated materials within a chamber;
providing an opposed anode and cathode configured to support a current across the chamber;
positioning an anionic semipermeable membrane between the anode and cathode;
applying a current between the anode and cathode to attract the poly- and/or perfluoroalkyl fluorinated materials towards the anode and onto the anionic semipermeable membrane; and
the semipermeable membrane retaining poly- and/or perfluoroalkyl fluorinated materials;
wherein the anionic semipermeable membrane comprises at least 0.0005% by total weight of the anionic semipermeable membrane of a cationic compound adhered to the anionic semipermeable membrane.

The method may have the anionic semipermeable membrane abut the anode and maintains a second aqueous liquid between the anode and the anionic semipermeable membrane. The method may also have the second aqueous liquid be substantially free of poly- and/or perfluoroalkyl fluorinated materials. The method may also have a cationic semipermeable membrane abut the cathode and maintain a third aqueous liquid between the cathode and the cationic semipermeable membrane. The cathodic membrane is often used instinctively in the design of chambers, but is not essential for the remediation of aqueous masses having poly- or perfluoroalkyl fluorinated materials which are overwhelmingly anionic. However, to obtain maximum extraction of poly- or perfluoroalkyl fluorinated materials, the cationic semipermeable membrane is typically employed.

It was stated above that the anionic semipermeable membrane comprises at least 0.0005% by total weight of the anionic semipermeable membrane of a cationic compound adhered to the anionic semipermeable membrane. There are a number of considerations about the amount of PFAS retaining composition (PRC) on the anionic semipermeable membrane that is beneficial. Essentially, any measurable amount added increases the effective retention of PFAS on the ASM. The only upper limit on amounts of the PRC would be such an amount that excessively (more than 1%) or substantially fills (more than 15% or more than 25%) all or most more than 50%) of the pores in the ASM. The PRC may coat or line the pores, but should not close off accessibility into the pores. Additionally, the presence of the PRCs is most effective on the side of the ASM facing away from the anode (the distal side with respect to the anode). The efficiency of retention is so great, and the rate of entry of aqueous media into the pores is so relatively slow that the most rapid majority of retention occurs within the distal at least 10% and up to about 25% of the ASM, within the distal 50% of the ASM, and clearly within the distal 75% of the ASM. It is therefore optional to have the majority of the PRC within the distal 75%, 50% and even 25% of the distal volume of the ASM, even though it might be easier from a manufacturing standpoint to have the PRC essentially uniformly distributed throughout the ASM. The remaining thickness of the ASM without PRC on its surface tends to primarily add structural strength to the ASM. To that end, an ASM at the thinnest edge of the ranger of thicknesses allowed (30 μm, or even less at 20 μm) can be used if the proximal face of the ASM closest to the anode has a chemically inactive (to the environment) support layer abutting or bonded to that proximal face.

Because the retention is an essentially surface phenomenon, in that the PFAS is not merely absorbed into the composition of the uncoated ASM, but primarily retained on its surface, any majority of the PRC additive should be on the surface of the ASM composition. The coating may be discontinuous, as it would be with the smaller proportions by eight or volume to that of the PRC, or approach a continuous coating over the surface of the still-open pores, without clogging the opening to the pores. Again, the emphasis should be on adding PRCs on a distal face of the ASM. Most one-sided coating processes (e.g., spin coating, blade coating, extrusion coating, spray coating, single side dip coating, sputter etching, etc.) would tend to distribute higher concentrations of PRC on one face/side of the ASM, which likely would be the distal side of the ASM.

With only interior pore surfaces being the objective of the applied solid PRC material to the ASM, extremely small proportions of the PRC to the ASM may be used.

Amounts lower than the weight of the uncoated anionic semipermeable membrane comprising at least 0.0001% or at least 0.0005% by total weight of the anionic semipermeable membrane of a cationic compound adhered to the anionic semipermeable membrane will still show some improvement in PFAS retention. This is particularly true where the highest concentration of PRC is distributed more heavily on one side (the distal side) of the ASM. It is unlikely that the total amount of PRC would ever exceed about 15% or ever exceed 10% of the total weight of the untreated ASM when there is a one-sided coating technique because of the likelihood of forming a continuous film and access to the pores being blocked.

Proteins are generally defined as any of a class of nitrogenous organic compounds that have large molecules composed of one or more long chains of amino acids and are an essential part of all living organisms, especially as structural components of body tissues such as muscle, hair, etc., and as enzymes and antibodies.

Proteins are large biomolecules and macromolecules that comprise one or more long chains of amino acid residues. Proteins perform a vast array of functions within organisms, including catalyzing metabolic reactions, DNA replication, responding to stimuli, providing structure to cells and organisms, and transporting molecules from one location to another. Proteins differ from one another primarily in their sequence of amino acids, which is dictated by the nucleotide sequence of their genes, and which usually results in protein folding into a specific 3D structure that determines its activity.

A linear chain of amino acid residues is called a polypeptide. A protein contains at least one long polypeptide. Short polypeptides, containing less than 20-30 residues, are rarely considered to be proteins and are commonly called peptides. The individual amino acid residues are bonded together by peptide bonds and adjacent amino acid residues. The sequence of amino acid residues in a protein is defined by the sequence of a gene, which is encoded in the genetic code. In general, the genetic code specifies 20 standard amino acids; but in certain organisms the genetic code can include selenocysteine and—in certain archaea—pyrrolysine. Shortly after or even during synthesis, the residues in a protein are often chemically modified by post-translational modification, which alters the physical and chemical properties, folding, stability, activity, and ultimately, the function of the proteins. Some proteins have non-peptide groups attached, which can be called prosthetic groups or cofactors. Proteins can also work together to achieve a particular function, and they often associate to form stable protein complexes.

Once formed, proteins only exist for a certain period and are then degraded and recycled by the cell's machinery through the process of protein turnover. A protein's lifespan is measured in terms of its half-life and covers a wide range. They can exist for minutes or years with an average lifespan of 1-2 days in mammalian cells. Abnormal or misfolded proteins are degraded more rapidly either due to being targeted for destruction or due to being unstable.

Like other biological macromolecules such as polysaccharides and nucleic acids, proteins are essential parts of organisms and participate in virtually every process within cells. Many proteins are enzymes that catalyze biochemical reactions and are vital to metabolism. Proteins also have structural or mechanical functions, such as actin and myosin in muscle and the proteins in the cytoskeleton, which form a system of scaffolding that maintains cell shape. Other proteins are important in cell signaling, immune responses, cell adhesion, and the cell cycle. In animals, proteins are needed in the diet to provide the essential amino acids that cannot be synthesized. Digestion breaks the proteins down for metabolic use.

Proteins were first described by the Dutch chemist Gerardus Johannes Mulder and named by the Swedish chemist Jöns Jacob Berzelius in 1838. Mulder carried out elemental analysis of common proteins and found that nearly all proteins had the same empirical formula, C₄₀₀H₆₂₀N₁₀₀O₁₂₀P₁S₁. He came to the erroneous conclusion that they might be composed of a single type of (very large) molecule. The term “protein” to describe these molecules was proposed by Mulder's associate Berzelius; protein is derived from the Greek word πρ\acute{ω}τειοζ (proteios), meaning “primary”, “in the lead”, or “standing in front”, +-in. Mulder went on to identify the products of protein degradation such as the amino acid leucine for which he found a (nearly correct) molecular weight of 131 Daltons (Da).

The understanding of proteins as polypeptides, or chains of amino acids, came through the work of Franz Hofmeister and Hermann Emil Fischer in 1902._{[10][11]} The central role of proteins as enzymes in living organisms that catalyzed reactions was not fully appreciated until 1926, when James B. Sumner showed that the enzyme urease was in fact a protein._{[12]}

Linus Pauling is credited with the successful prediction of regular protein secondary structures based on hydrogen bonding, an idea first put forth by William Astbury in 1933._{[13]} Later work by Walter Kauzmann on denaturation,_{[14][15]} based partly on previous studies by Kaj Linderstrøm-Lang,_{[16]} contributed an understanding of protein folding and structure mediated by hydrophobic interactions.

The first protein to have its amino acid chain sequenced was insulin, by Frederick Sanger, in 1949. Sanger correctly determined the amino acid sequence of insulin, thus conclusively demonstrating that proteins consisted of linear polymers of amino acids rather than branched chains, colloids, or cyclols.

Proteins are primarily classified by sequence and structure, although other classifications are commonly used. Especially for enzymes the EC number system provides a functional classification scheme. Similarly, the gene ontology classifies both genes and proteins by their biological and biochemical function, but also by their intracellular location.

Sequence similarity is used to classify proteins both in terms of evolutionary and functional similarity. This may use either whole proteins or protein domains, especially in multi-domain proteins. Protein domains allow protein classification by a combination of sequence, structure and function, and they can be combined in many different ways. In an early study of 170,000 proteins, about two-thirds were assigned at least one domain, with larger proteins containing more domains (e.g. proteins larger than 600 amino acids having an average of more than 5 domains).

Another common system uses Greek letter prefixes as locants, which is useful in identifying the relative location of carbon atoms as well as hydrogen atoms to other functional groups.

The α-carbon (alpha-carbon) refers to the first carbon atom that attaches to a functional group, such as a carbonyl. The second carbon atom is called the β-carbon (beta-carbon), the third is the y-carbon (gamma-carbon), and the naming system continues in alphabetical order._{[2]}

The nomenclature can also be applied to the hydrogen atoms attached to the carbon atoms. A hydrogen atom attached to an α-carbon is called an α-hydrogen, a hydrogen atom on the β-carbon is a β-hydrogen, and so on.

Organic molecules with more than one functional group can be a source of confusion. Generally the functional group responsible for the name or type of the molecule is the ‘reference’ group for purposes of carbon-atom naming. For example, the molecules nitrostyrene and phenethylamine are quite similar; the former can even be reduced into the latter. However, nitrostyrene's α-carbon atom is adjacent to the phenyl group; in phenethylamine this same carbon atom is the β-carbon atom, as phenethylamine (being an amine rather than a styrene) counts its atoms from the opposite “end” of the molecule.

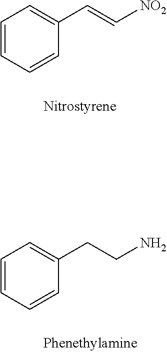 [SMILES: O=[N+]([O-])/C=C/c1ccccc1 ; NCCc1ccccc1]

### Proteins and Amino Acids

In proteins and amino acids, the α-carbon is the backbone carbon before the carbonyl carbon atom in the molecule. Therefore, reading along the backbone of a typical protein would give a sequence of —[N—Cα-carbonyl C]ₙ— etc. (when reading in the N to C direction). The α-carbon is where the different substituents attach to each different amino acid. That is, the groups hanging off the chain at the α-carbon are what give amino acids their diversity. These groups give the α-carbon its stereogenic properties for every amino acid except for glycine. Therefore, the α-carbon is a stereocenter for every amino acid except glycine. Glycine also does not have a β-carbon, while every other amino acid does.

The α-carbon of an amino acid is significant in protein folding. When describing a protein, which is a chain of amino acids, one often approximates the location of each amino acid as the location of its α-carbon. In general, α-carbons of adjacent amino acids in a protein are about 3.8 ångströms (380 picometers) apart.

Primary Structure: The primary structure of a protein is its amino acid sequence. The base (repeat) sequence of the gene codes are comprised of three amino acids (glycine; proline; «x»-any other amino acid). This sequence of amino acids bonded together creates a polypeptide (poly=many) bond, or chain. The primary structure of a protein is linear.

Secondary Structure: The secondary structure takes the chains (primary) and folds, or coils them. These parts attract to one another to form structures that have a (alpha)-helices and β (beta)-pleated sheets. These form as a result of hydrogen bonds between the peptide groups of the main (primary) chain. These secondary-structure proteins contain regions that are cylindrical (α-helices, spiral shape) and/or regions that are planar (β-pleated sheets, ribbon with peaks and valleys). The secondary structure of a structure is three dimensional.

Tertiary Structure: The tertiary structure of a protein is its three-dimensional conformation that is created when the protein folds. Hydrogen bonds stabilize the folding occurrences. Other intramolecular bonds that stabilize the folding processes include hydrophobic interactions; ionic bonds; and disulfide bridges. These bonds are formed between the R groups of amino acids. They contain the nonpolar parts of proteins which result in attractions and repulsions and become coiled up in one area, creating a very complex structure. The tertiary structure is the overall shape of the protein for which most are globular in shape, or fibrous—long and thin.

Quaternary Structure: A quaternary structure is formed when two or more tertiary polypeptide chains form a single or full protein. Certain proteins may have a non-polypeptide structure, thus belonging to a prosthetic group, while other proteins are conjugated. Here unique patterns are formed via hydrogen bonding.

### Chemical Bonding in Proteins

The amino acids of a polypeptide are linked together in chains by their neighboring covalent bonds (peptide bonds). In turn, each bond forms in a dehydration synthesis (condensation) reaction. Throughout the protein-synthesis process, the carboxyl group of the amino acid reacts with the amino group of an incoming amino acid, releasing a molecule of water. This process occurs at the end of the growing polypeptide chain, thus resulting in a bond between amino acids, known as a peptide (or polypeptide) chain.

In addition to the polypeptide bonds, sulfide bridge formations and Schiff base formations are two other chemical reactions that can take place during cell activities that are «directed» by amino acids, which comprise the basis of all proteins.

The amino acids' interactions cause a protein to fold into its mature shape (tertiary). Such folding happens because of the rotation of bonds within the amino acids, as well as bonds joining various amino acids.

Peptide bonds form between the carbonyl carbon and the nitrogen, which is another peptide bond. Nitrogen bonds to carbonyl carbon, then to the peptide linkage, back to the nitrogen, and so on. From the chains, the backbones are interacting. Furthermore, nitrogen is electro-negative such that it consumes electrons from the nitrogen. Here the hydrogen has a partially positive charge.

Conversely, oxygen is electro-negative. Oxygen takes electrons from the carbon which gives oxygen a partially negative charge. Simply put, the hydrogen and the oxygen are attracted to each other, creating a hydrogen bond. From there, these two connected chains form a β-pleated sheet. The backbones then interact with each other and move in the same direction, which is known as a parallel β-pleated sheet.

The β-pleated sheet takes on a certain pattern, moving in the order of nitrogen, α carbon, and then carbonyl carbon. This is on the left side of the protein. On the right side, the pattern moves in the order of carbonyl carbon, α carbon, and then nitrogen. Note that these processes are traveling in opposite directions with the hydrogen bonds between these partially positive ends of the nitrogen-hydrogen bonds remaining at the hydrogen end. The hydrogen bonds and the backbones are still parallel, but again, they are moving in different directions. This is called an anti-parallel β-pleated sheet, which is another form of a secondary structure.

The backbone of the protein can also become a helical structure (also a secondary structure) where the hydrogen bonds form between the different layers of the helix. Remember that oxygen has a partially negative charge, and that hydrogen has a partially positive charge. At any rate, the resulting hydrogen bond gives the protein its helical structure. So these interactions highlight the in-depth and interrelational processes that create the structure, dynamics, and the functions of proteins.

All proteins have the above-mentioned processes in common, but not all proteins possess the more complicated and interactive tertiary and quaternary structures. Several molecular interactions and thermodynamic changes can transpire within these highly complex molecular structures of protein.

A non-limiting list of proteins that are believed to be able to function within the scope of the present invention follows. It is to be noted that based on general knowledge of PFAS ability to fix to proteins, which is one of the main medical problems with PFAS in the environment, all proteins are likely to work, but some would be more economically efficient than others.

### Fibrous Protein

### Cytoskeletal Proteins

Tubulin; actin; FtsZ %; keratin; myosin; Tau (protein); dystrophin

### Extracellular Matrix Proteins

Collagen; Elastin; Reelin; F-spondin; Clobular proteins

### Plasma Proteins

Serum albumin; Serum Amyloid P Components

### Coagulation Factors

See also: {{Coagulation}}
Fibrin; Thrombin; Factors XIII and VIII; Von Willebrand Factor; Proteins C, S, Z and Z-related protease inhibitor; Complement proteins; C1-inhibitor; C3-convertase

### Acute Phase Proteins

C-reactive protein;

### Hemoproteins

Hemoglobin; myoglobin;

### Cell Adhesion

Cadherin; integrin; NCAM; selectin

### Transmembrane Transport Proteins

Ion pumping enzymes are in the enzymes section.
CFTR; Glycophorin C; Scramblase; Ion channels; Acetylcholine receptor and Nicotinic Acetylcholine receptor; Potassium channel; synport/antiport proteins; Glucose transporter

### Hormones and Growth Factors

Oxytocin; insulin; epidermal growth factor; Insulin-like growth factor

### Receptors

Transmembrane receptors; G-protein-coupled receptor; Rhodopsin; Intracellular receptors
Estrogen receptor

### DNA-Binding Protein

Histones; CI protein %; C-myc; MyoD
FOXP2; FOXP3; P53

### Immune System Proteins

Immunoglobulins; T Cell receptors; Major Histocompatability antigens

### Nutrient Storage/Transport

ferritin
   Chaperone proteins GroEL%

### Enzymes

### Complexes With Multiple Components Including Proteins

spliceosome; ribonucleoprotein (generic); Signal recognition particle; nucleosome;

### Structural Alternatives to Semipermeable Membranes as PFAS Collectors

In the entire background of literature on filtration, capture and retention of PFAS materials (also referred to in the art as ‘poly- and/or perfluoroalkyl fluorinated material contaminants’, it has been traditionally held that a semipermeable membrane was the only, or at least the most preferred element for the filtration, post-filtration capture by an anode and retention by an anode of PFAS contaminants. Except where the contaminants are being carried in association with a more macroscopic solid contaminant, physical filters, such as porous masses, would not be expected to offer even the potential for high percentages (e.g., at least 70%, at least 80%, at least 90%, or more than 95% up to 99%-100%) capture in a single pass through or adjacent to the porous mass.
It has been surprisingly found that a structural sheet of substantially any porous material, if activated (coated, continuously or discontinuously, by a PFAS enhanced-retention composition may be used to replace the more expensive semipermeable membrane. For example, a reticulated foam, porous sheet (e.g., with etched or otherwise provided pores through the sheet), fabrics (non-woven, woven, knitted, layered), cellulosic sheets, composites of cellulosic materials, ceramics, glasses, metals, and polymers (especially ethylenically-based polymers (polyethylene, polypropylene, polystyrene and copolymers thereof and therewith) nylons and other amido-group containing synthetics), carbon or graphite fibers, and any other sheets of film that has at least

[symbol]

In its definitions of air filtration terminology, ISO 29464 clearly distinguishes between the overall medium area and the effective medium area of an air filter. The overall filter area is the total area of filter medium contained in an air filter. The effective filter area, on the other hand, is defined as the medium area through which air passes, i.e., the area actually available for particulate filtration. Areas covered by adhesives, struts etc. do not count as effective filter area (See ISO 29464 (2011), p. 2). ISO 29461-1:2021 Annex A uses a similar definition. This standard for air intake filter testing for rotary machinery, and defines the effective filter area as the filter medium area available for particle separation (See ISO 29461 (2021) Annex A, p. 3).

As can be seen in the diagram below, fractional efficiency is essentially unchanged for filters with different effective areas over the particle size spectrum above 0.3 μm.

The two filters compared are the MPK 48-20 GT (effective filter area 17.6 m²) and the MPK 48-31 GT (effective filter area 25.3 m²). Both are ISO ePM filters as classified by ISO 16 890 (formerly classified as: F8 according to EN 779).

As can be seen from the plot, the increased effective filter area has only minimal effect-on filtration performance at least-over the particle size spectrum considered (>0.3 μm).

Cellulose acetate (CA) membranes have a very low binding affinity for most macromolecules and are especially recommended for applications requiring low protein binding, such as filtering culture media containing sera. However, both cellulose acetate and cellulose nitrate membranes are naturally hydrophobic and have small amounts (less than 1%) of non-toxic wetting agents added during manufacture to ensure proper wetting of the membrane. If desired, these agents can be easily removed prior to use by filtering a small amount of warm purified water through the membrane or filter unit. Surfactant-free cellulose acetate membranes with very low levels of extractables are available on some Corning® syringe filters. Cellulose nitrate (CN) membranes are recommended for filtering solutions where protein binding is not a concern. They are recommended for use in general laboratory applications such as buffer filtration. Corning's cellulose nitrate membranes are Triton™ X-100-free and noncytotoxic. Nylon membranes are naturally hydrophilic and are recommended for applications requiring very low extractables since they do not contain any wetting agents, detergents or surfactants. Their greater chemical resistance makes them better for filtering more aggressive solutions, such as alcohols and DMSO. However, like cellulose nitrate membranes, they may bind greater amounts of proteins and other macromolecules than do the cellulose acetate or PES membranes. They are recommended for filtering protein-free culture media. Polyethersulfone (PES) membranes are recommended for filtering cell culture media. PES has both very low protein binding and extractables. PES also demonstrates faster flow rates than cellulosic or nylon membranes. Regenerated cellulose (RC) membranes are hydrophilic and have very good chemical resistance to solvents, including DMSO. They are used to ultraclean and de-gas solvents and mobile phases used in HPLC applications. Polytetrafluorethylene (PTFE) membranes are naturally and permanently hydrophobic. They are ideal for filtering gases, including humidified air. The extreme chemical resistance of PTFE membranes makes them very useful for filtering solvents or other aggressive chemicals for which other membranes are unsuitable. Because of their hydrophobicity, PTFE membranes must be prewetted with a solvent, such as ethanol, before aqueous solutions can be filtered. Glass fiber filters are used as a depth filter for prefiltration of solutions. They have very high particle loading capacity and are ideal for prefiltering dirty solutions and difficult-to-filter biological fluids, such as sera. Corning Filter Housing Materials The filter housing materials, as well as the filter membrane must be compatible with the solutions being filters. Polystyrene (PS) is used in the filter funnels and storage bottles for the Corning plastic vacuum filters. This plastic polymer should only be used in filtering and storing nonaggressive aqueous solutions and biological fluids. Acrylic copolymer (AC) and Polyvinyl chloride (PVC) are used in some of the Corning syringe filter housings. These plastics should only be used in filtering nonaggressive aqueous solutions and biological fluids. Polypropylene (PP) is used in the Spin-X® centrifuge filters and some of the syringe and disc filter housings. This plastic polymer has very good resistance to many solvents.

Filter Diameter/Dimension Effective Filter Expected and Description Area (cm2) Throughput (mL) 15 mm syringe/disc 1.7, 3-15—25 mm syringe/disc; 4.8, 10-50—26 mm syringe/disc; 5.3, 10-50—28 mm syringe/disc 6.2, 10-50 50 mm disc; 19.6 100-500—42 mm vacuum system/square; 13.6, 100-500—49.5 mm vacuum system/square; 19.6, 200-750—63 mm vacuum system/square; 33.2, 300-1500—79 mm vacuum system/square; 54.5 500-3000. These values assume an aqueous solution and a 0.2 micron membrane. Solutions containing sera or other proteinaceous materials will be at the lower end of the range. Use of prefilters may extend the throughput 50 to 100% above the values shown.

In general, the pore size of filter membranes is usually dictated by the requirements of the filter application rather than the desired flow rate. Larger pore membranes usually have both faster flow rates and greater capacity before pore clogging slows the flow. As expected, the initial flow rate (steep part of the curve) of the 0.45 μm filter was approximately twice that of the 0.22 μm filter, although its capacity or throughput prior to clogging (the area at the plateau) was only about 20% greater. In the practice of the present invention, solely for throughput requirements, pore sizes should be between 0.2 μm to 2.0 mm. The adsorption/absorption sheets should have an effective filter area of at least 0.10 to 50 m2 according to ISO 29464 (2011), p. 2.

The proportions of adherent agent to filter structural material should be at least 0.05%, or at least 0.1% adherent agent, up to a maximum of 15% adherent agent per weight of the structural material. Preferably, the proportions of adherent agent to structural material should be from 0.25% to 10%, or 0.5% to 5% on a weight: weight basis.

The adherent agent is inclusive (on the side of the PFAS mediation device closest to the anode) is selected from the groups consisting of cationic materials (as defined herein) and proteinaceous materials on the surface of the porous structure.

Similarly, on the cathode side of the device, the same porous materials may be used, but with an anionic coating material thereon. The porous material on the cathodic side, because of its lower functionality in the practice of the invention, mat be uncoated, or coated with the same proportions of an anionic coating material (as defined herein).

As some of these sheet materials have modest structural stability (e.g., especially the fabrics), it is likely that structural reinforcement elements may be embedded in or attached to the sheet materials, as with a rigid or semi-rigid mesh, frame, array of posts, and the like. The contaminant retaining sheets may have a thickness of from 30 μ to 2 mm. Preferably it is from 50 μ to 1 mm.

Commercial available filter materials, HEPA or not, may be used as the porous medium structure. These may be coated with the relevant anionic or cationic adsorbants or absorbants at a much lower cost than the semipermeable membranes. Many of these commercial materials are chemically stable (e.g., glass, ceramic, polypropylene, nylon, cellulose acetate, cellulose nitrate) and are suitable for use in the present invention, with the adsorbant enhancing compositions added thereto.

As defined herein, an “anionic PFAS (or also poly- and/or perfluoroalkyl fluorinated material contaminants) retaining sheet” is a porous sheet (within the limitations of porosity defined herein) having at least 5% of its exposed surface area fixed to an adsorbant enhancing composition selected from the group consisting of cationic materials (as defined herein) and proteinaceous materials (as well understood in the art and defined herein). P: roetinaceous meaning any chemical material having a structural similarity to and functional activity to the properties of a protein.

The following features of the AEC of the present invention are thought to include at least the following:
It utilizes electrostatic separation for removal of PFAS chemical species that are not purely ionic in character, or that may be only slightly ionic.
Separation can be accomplished in a liquid with a relatively low total ionic strength (generally less than 500 mg/L TDS).
The low ionic strength of the initial feed liquid allows greater concentration in subsequent treatment stages as bulk ionic species are removed and concentrated along with the PFAS.
The concentrated PFAS are then more amenable to treatment using granular activated carbon (GAC) and advanced oxidation processes (AOP).
The AEC uses a combination of anion and cation exchange membranes to facilitate collection of the PFAS to minimize interaction of ionic species.
Collection/concentration focuses on anions (i.e., PFAS), and only chamber is used for initial collection of PFAS, although multiple chambers could be used.

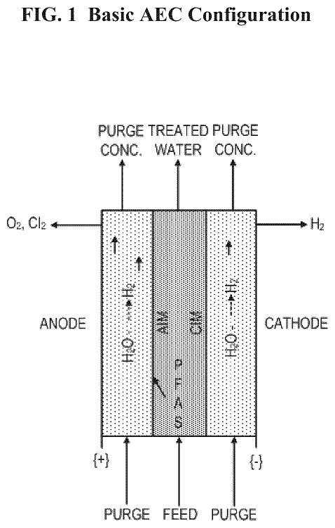

The AEC, in an explanation of its simplest form of use involves subjecting a water stream containing PFAS to opposing positive and negative electrically charged surfaces within a batch or flow-through module that includes ion exchange membranes to facilitate ion transfer and collection. The electrical charges are bisected by thin (50 micron typically) thick sheets of anion/cation exchange membrane, and a suitable open volume on both the anode and cathode sides of the membranes to allow the water to pass. FIG. 1 shows a basic 3-chamber AEC. Water flow occurs through the center section (feed chamber) of the device, while the anode/cathode sides of the membrane have no or reduced induced water flow, to allow concentration of removed materials. The electrically charged PFAS molecules in the water are attracted toward and are transferred across the anion exchange membrane depending on their charge affinity.

The three chambers in the basic module include:
Feed Chamber—This is the center chamber of a 3-chamber AEC. In a batch system, PFAS contaminated water is placed in the feed chamber, and at the end of treatment is removed. In a flow-through system, the feed enters one side of the Feed Chamber and treated water exits the other side.
AEM Chamber (anodic electrode chamber)—This is the chamber that is between the AEM chamber and the Anode electrode. In a batch system, this chamber is initially filled with water. At the end of the treatment cycle this stream contains any concentrated PFAS and salt transferred from the Feed Chamber. Upon removal from the AEC this stream is either further treated to remove PFAS or is further concentrated by passing it through another AEC module.
CEM Chamber (cathodic electrode chamber)—This is the chamber that is between the CEM and the Cathode electrode. In a batch system, this chamber is initially filled with water. At the end of the treatment cycle this stream, is normally stored and after the AEM stream is further treated/concentrated it is recombined with the CEM Chamber liquid (that has been further treated) to provide neutralization prior to recombination of this water with the treated water from the Feed Chamber.

The electrodes may require periodic cleaning by removing and/or reversing the polarity, while purging the contents that have accumulated within the collection area of the cell. In application, during this purge sequence, inlet flow may be diverted using automatic valving to a parallel AEC module or bank of modules.

Another embodiment of the system involves use of multiple individual AEM and CEM chambers operated in parallel. This allows, as with standard desalination technologies, the installation of multiple AEM/CEM cells within a single electrode bank.

Operation of two or more AEC modules in series allows the control of the operating voltage and thus limit the maximum current flux through an individual module. For example, an initial AEC module may operate at 60 VDC, while the second in series is operated at 200 VDC. In this example the first module would function to remove the bulk of PFAS, where the 2^{nd} in series would operate at a higher voltage to remove that last fractions of PFAS from the feed water stream.

It is envisioned that a full-scale unit would be controlled using a programmable logic controller (PLC) and human machine interface (HMI). Voltage control with electrical current limiting circuitry is envisioned to control the voltage supplied to each stage.

It is contemplated that this proprietary AEC technology will benefit target customers by producing a concentrated PFAS steam that can either be recycled or destroyed using other technologies such as AOP, or in conjunction with subsequent activated carbon (e.g. GAC) treatment of the concentrate. It has also been identified, as later disclosed, that PFAS may actually be chemically modified or decomposed by this process into harmless or less harmful non-PFAS species. It is believed that when AEC concentrate is treated using GAC, the pre-concentration can reduce both GAC bed size and bed replacement frequency. Specifically, the higher PFAS concentration from AEC combined with lower treatment volume allows higher PFAS loadings on the GAC, as compared to a GAC system that treats the whole effluent. A GAC system is typically sized such that when the 1^{st} bed outlet reaches half the treatment standard, that bed is replaced. At the 70 parts per trillion (ppt) EPA advisory level for total PFOA and PFOS, very little of the carbon's total capacity is used before it must be disposed or thermally regenerated at an offsite location. Treating concentrated PFAS using GAC has the potential to provide lower overall treatment cost, and a smaller overall physical footprint of the GAC treatment train because fewer or smaller GAC beds would be needed.

AEC may also produce a low volume concentrate stream containing the concentrated PFAS that could be treated directly using other technologies such as AOP. Recovery and recycling is also a potential option with the AEC. Similar synergies of treatment effectiveness occur with AOP, as AOP treatment is more cost effective at higher concentrations. These factors combined will enable affordable treatment of water for PFAS in applications and locales where PFAS treatment would otherwise be cost-prohibitive, thereby reducing the overall risk associated with PFAS exposure across the United States. Another benefit of the AEC use in industrial settings is that the treated feed stream will have a low conductivity, making it suitable for boiler feed makeup water.

### Overall AEC Dimensions and Configuration

The AEC assembly (module), as tested measured 3×8 inches [7.6×20.3 cm]. The unit consisted of an outer polycarbonate support (5 mm), anode and cathode electrodes (Titanium), anode/cathode/feed chambers (5 mm) polycarbonate, and butyl rubber gasketing. Each chamber included three 2-inch×2-inch (5×5 cm) chambers that were interconnected by flow channels. The AEM and CEM were each “sandwiched” between two sheets of gasket material, and the semipermeable membranes were cut to fill the entire inner surface of the respective chambers.

For the Activity I (batch) testing, the AEC module was oriented horizontally, with vent holes in each chamber to allow the escape of gases. Between each chamber were 3 channels to connect the three chambers. For Activity II (flow-through) testing, the unit was oriented vertically, with a vent hole on the anode chamber. Entry and exit ports for liquid (and some gas) were located at the bottom and top sides of each chamber. Silicon tubing was used in Activity II testing.

### AEC Ion Exchange Membranes

The ion exchange membranes used in the testing included polymeric membranes such as Fumatech's Fumasep® FAS-50 (anion exchange membrane), Fumasep® FKS-50 (cation exchange membrane), and Chemour's Nafion® 117 (cation exchange membrane. Key specifications for these membranes are presented in Table 2-1. Fumasep® membranes are typically available in 20×20 cm (7.9×7.9 in), 52×52 cm (20.5×20.5 in), and 52×105 cm (20.5×41.3 in) with a maximum roll width of 165 cm (65 in). Nafion® membrane products are available in 12 in (4.7 cm) and 24 in (9.4 cm) widths, with a 50 meter (m), or 164 ft standard roll length.

TABLE 2-1
Ion Exchange Membrane Specifications

| Parameter | Units | FAS-50 | FKS-50 | Nafion-117 |
|---|---|---|---|---|
| Color | Specify | Amber | Clear | |
| Material | Specify | | | PFSA |
| Form delivered | Specify | Bromide | | H+ |
| Thickness | Um | 45-50 | 45-55 | 183 typ. |
| Reinforcement | Specify | None | None | |
| pH Range | Std. Units | 1-14 | 1-14 | |
| Storage | wt. % NaCl | 0.5-1.5 | 0.5 to 1.5 | |
| Exchange | meq/g | 1.6-1.8 | 1.3-1.4 | 0.95-1 |
| Capacity | | | | |
| Proton Transfer | umol/min- | 1000-3000 | NA | |
| Rate | cm² | | | |
| Selectivity | % | 92-97 | 98-99 | |
| Specific | Ohm/cm² | 0.4-0.8 | 0.9-1.9 | |
| Resistance | | | | |
| Typical current | mA/cm² | 10-20 | 10-20 | NA |
| flux | | | | |

PFSA—copolymer of tetrafluoroethylene and perfluorinated monomers containing sulfonic acid groups.

### Introduction to AEC Testing

Testing of the AEC was conducted in two operational modes that included batch testing (Activity I), and flow-through testing (Activity II). Parametric and other specific testing was conducted during each of these activities.

### AEC Configuration Modifications During Test Program

The primary testing variation during AEC testing was the addition of spacers in the center channel of the AEC. This modification was implemented during flow-through testing as a result of membrane damage caused by the elasticity of the membrane. The modification involved placing polypropylene mesh weave within the feed chamber to prevent the AEM and CEM from deforming into the feed chamber. During testing activities, the AEM showed the greatest potential for deformation.

As an alternative to the mesh, extruded lines of polymer (resistant to the chemical activity in the various liquids) can be placed over the membrane to stiffen the membrane against distortion or deformation. Silicone polymers, fluorinated polymers, and polyethylene or polypropylene polymers are non-limiting examples of useful class of polymers not likely to rapidly degrade in the harsh environment of the AEC liquids.

### Batch Testing Results (Activity I)

The first testing activity involved evaluation of AEC performance in batch mode. This test series is referred to as Activity I. Later flow-through testing is referenced as Activity II. Test run numbering convention is as follows: Activity-Test-Run. Using this convention 1-1-1 would be Activity I (Batch), Test 1, Run 1.

The Activity I batch testing apparatus was configured as described above.

### Batch Testing Protocol

Batch testing involved operating the AEC at a range of treatment times and voltages. Initial runs (10-01 through 1-0-25) were conducted to gain familiarity with the performance on the test feed solution, which consisted of sodium chloride mixed in deionized (DI) water at concentrations of 25, 250, and 500 mg/L. During testing the conductivity was measured using a conductivity meter as micro-Siemens per centimeter (uS/cm). Conductivity readings can be converted to mg/L NaCl by multiplying by a factor of 0.5.

Testing under the test matrix was conducted at three voltages, 10, 30 and 50 volts direct current (VDC), with test run durations of 5, 10, and 20 minutes. During one test of the Activity 1 suite a different CEM, Nafion® 117 membrane, was used in lieu of the Fumasep® FKS membrane that was used for all other tests.

### Modifications to Original Activity I Protocol

Key change from the original test protocol and key modifications are as follows:
Test 1-1-7 through 1-1-9 were not conducted. These runs were to be conducted without the CEM. When the first test run was conducted at this condition, the AEC failed to reduce feed chamber conductivity, and the membranes were damaged. Subsequent tests in this series were abandoned.
A test [test 1-10-(1-3)] was added to evaluate the impact of adding exfoliated graphite to the side chambers to assess the impact on salt removal and AEC overall resistance.
A test [Test 1-11-(1-3)] was added to evaluate the impact of side chamber conductivity on performance relative to salt removal.

### Batch Testing Results

Results from the initial batch testing are presented for both PFAS removal and salt removal are provided in the text below.

### PFAS Removal Results

PFAS operational and analytical results from the Activity 1 AEC batch testing are presented in Table 3-1. This table does not include testing where PFAS were not sampled and analyzed. Other tests as described further below were conducted to evaluate specific operating aspects on performance characteristics. A table presenting all test results is provided below. Tests 1-1-1 through 1-3-9 were all conducted with the same electrode spacing and using the same membranes (FumaSep® membrane).

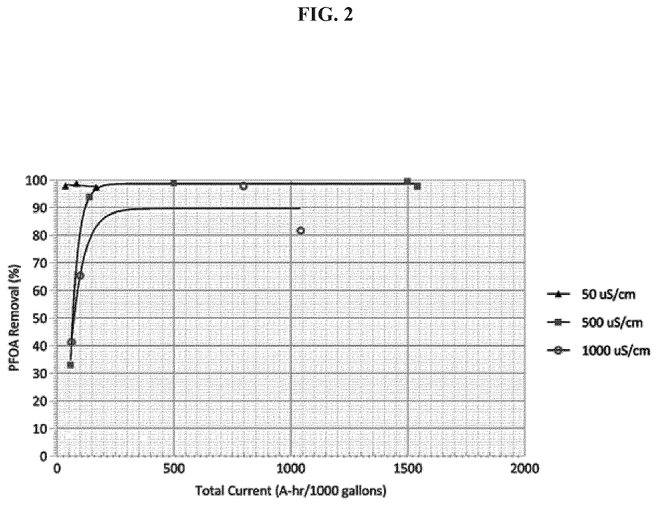

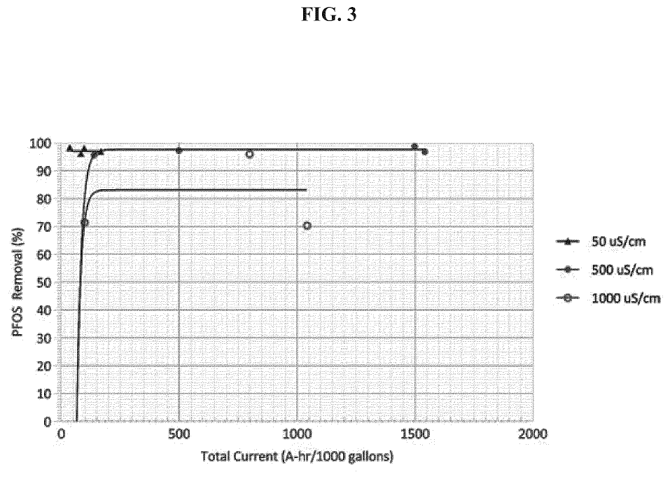

Test results showed effective removal of both PFOA and PFOS at total applied current above about 200 A-hr. 1000 gallons treated, with feed concentrations being reduced from 100 ppb each PFOA/PFOS to less than 2 ppb. FIG. 2 provides a plot of percent PFOA removal as a function of applied current, and FIG. 3 provides the same plot for PFOS. Both plots show a consistent linear relationship between applied current and PFAS removal up to around 200 milliamps (mA), where the percent removal abruptly flattens with additional total current application. Additionally, percent removal for both PFOA and PFOS are similar for the same total current input. The results also show that at lower salt concentrations, lower total current was required for the same percent PFAS reduction. Of importance, high PFOA/PFOS removal efficiencies were achieved over the range of salt concentrations tested (i.e., 100 to 1000 μS/cm).

### Batch Testing Program Operating Parameters Impacting Performance

The primary operating conditions monitored included conductivity, pH, voltage, current, and treatment time. The operating conditions were evaluated using multiple linear regression to identify key parameters affecting PFAS removal. The effects of temperature were not evaluated in this test although temperature was monitored as later discussed herein. In assessing the primary data set, the most significant operational parameters were determined to be current, treatment time, and initial feed conductivity. The current and time parameters were combined and are reported as mA minutes (mA-min) per 1000 gallons treated in this report. This value can be converted to Coulombs by multiplying mA-min by 0.06.

The primary data set evaluated in this section includes data from Runs 1-0-26, 1-0-27, 1-1-(1-9), 1-2-(1-9), and 1-3-(1-9), which represents the main test series (MTS).

Other evaluations outside the MTS included the following:
Test 1-4-(1-9)-conducted by substituting Nafion® 117 membrane for the Fumasep® FKS-50 membrane (included in MTS).
Test 1-5-(1-3)-conducted at 3.2 centimeter (cm) electrode spacing
Test 1-6-(1-3)-conducted at 4.0 cm electrode spacing
Test 1-10-(1-3)-conducted using expanded graphite inside the AEM and CEM chambers
Test 1-11-(1-3)-conducted to evaluate the effect of higher AEM and CEM chamber conductivities on performance

Test 1-4 was conducted using Nafion® 117 membrane in the CEM, and Test 1-5 and 1-6 were conducted at different electrode separation by increasing the volume (thickness) of the feed chamber. The results and findings from each of the above tests are discussed below.

TABLE 3-1
PFAS and Salt Removal Results-Activity I

| | | | Total | | | | Total | | | | | |
|---|---|---|---|---|---|---|---|---|---|---|---|---|
| | | | Current | | | | PFOA | | | | | |
| | Outlet | Outlet | Applied | | | | and | | | | | |
| | PFOA | PFOS | (A-hr)/ | | PFOA | PFOS | PFOS | Initial | Final | Salt | Electrode | |
| Test/ | Conc. | Conc. | 1000 | Voltage | Removal | Removal | Removal | Cond. | Cond. | Removal | Spacing | |
| Run | (ppb) | (ppb) | gal.) | (VDC) | (%) | (%) | (%) | (μS/cm) | (μS/cm) | (%) | (cm) | AEM/CEM |
| 1-0-26 | 0.94 | 0.94 | 499.1 | 30 | 98.9 | 97.3 | 98.4 | 500 | 11.2 | 97.76 | 2.5 | FAS/FKS |
| 1-0-27 | 5.06 | 1.51 | 139.2 | 59 | 93.8 | 95.6 | 94.4 | 507 | 2.7 | 99.47 | 2.5 | FAS/FKS |
| 1-1-1 | 0.48 | 1.67 | 36.0 | 10 | 7.59 | 98.3 | 34.6 | 54.6 | 26.7 | 51.1 | 2.5 | FAS/FKS |
| 1-1-6 | 1.79 | 1.35 | 81.5 | 30 | 97.8 | 96.1 | 97.3 | 54.7 | 0.5 | 99.1 | 2.5 | FAS/FKS |
| 1-1-8 | 1.00 | 1.07 | 167.8 | 50 | 98.8 | 96.69 | 98.2 | 53.5 | 0.8 | 98.5 | 2.5 | FAS/FKS |
| 1-1-9 | 0.59 | 0.66 | 97.7 | 50 | 99.3 | 98.1 | 98.9 | 51.7 | 0.7 | 98.7 | 2.5 | FAS/FKS |
| 1-2-2 | 54.63 | 53.51 | 57.8 | 10 | 33.0 | −54.6 | 6.94 | 479 | 380 | 20.7 | 2.5 | FAS/FKS |
| 1-2-3 | 81.59 | 76.27 | 372.7 | 10 | 6.5 | 17.48 | 9.8 | 494 | 108.5 | 78.0 | 2.5 | FAS/FKS |
| 1-2-6 | 1.90 | 1.10 | 1542.2 | 30 | 97.7 | 96.8 | 97.4 | 442 | 3.7 | 99.2 | 2.5 | FAS/FKS |
| 1-2-9 | 0.51 | 0.40 | 1498.8 | 50 | 99.4 | 98.8 | 99.2 | 509 | 3.7 | 99.3 | 2.5 | FAS/FKS |
| 1-3-1 | 47.94 | 41.44 | 62.2 | 10 | 41.2 | 19.7 | 23.1 | 960 | 800 | 16.7 | 2.5 | FAS/FKS |
| 1-3-3 | 28.31 | 9.90 | 98.7 | 10 | 65.3 | 71.4 | 67.1 | 936 | 20.6 | 97.8 | 2.5 | FAS/FKS |
| 1-3-5 | 14.99 | 10.28 | 1042.6 | 30 | 81.6 | 70.3 | 78.3 | 967 | 22.2 | 97.7 | 2.5 | FAS/FKS |
| 1-3-9 | 1.76 | 1.37 | 797.8 | 50 | 97.8 | 96.0 | 97.3 | 951 | 5.7 | 99.4 | 2.5 | FAS/FKS |
| 1-4-9 | 3.93 | 1.19 | 515.4 | 50 | 95.2 | 96.6 | 95.6 | 501 | 1.7 | 99.7 | 2.5 | FAS/Nafion |
| 1-5-3 | 13.17 | 4.53 | 889.6 | 50 | 83.9 | 86.9 | 84.8 | 512 | 7.1 | 98.6 | 3.2 | FAS/FKS |
| 1-6-3 | 33.28 | 11.72 | 1129.5 | 50 | 59.2 | 66.1 | 61.3 | 518 | 29.9 | 94.2 | 4.0 | FAS/FKS |

### Salt Removal Results

Salt removal results are summarized in Table 3-2 for all of the Activity I testing, whereas Table 3-1 only addresses results in runs where PFAS were analyzed.

The correlation between total current and salt removal followed a pattern very similar to that of the tested PFAS. Table 3-3 summarizes salt removal versus total current.

The same correlation is shown on a mass removal basis in FIG. 4. The mass removal in milligrams of NaCl, is based on a module volume of 63.9 milliliters (mL).

TABLE 3-2
Salt Removal Results-Activity I

| | Treated | Treated | Total | | | | | | | | |
|---|---|---|---|---|---|---|---|---|---|---|---|
| | PFOA | PFOS | Current | | PFOA | PFOS | Initial | Final | Salt | Electrode | |
| Test/ | Conc. | Conc. | (A-hr/ | Volts | Removal | Removal | Cond. | Cond. | Removal | Spacing | |
| Run | (ppb) | (ppb) | 1000 gal) | (V) | (%) | (%) | (uS/cm) | (uS/cm) | (%) | (cm) | AEM/CEM |
| 1-0-26 | 0.94 | 0.94 | 499.1 | 30 | 99.1 | 99.1 | 500 | 11.2 | 97.76 | 2.5 | FAS/FKS |
| 1-0-27 | 5.06 | 1.51 | 139.2 | 59 | 94.9 | 98.5 | 507 | 2.7 | 99.47 | 2.5 | FAS/FKS |
| 1-1-1 | 0.48 | 1.67 | 36.0 | 10 | 99.5 | 98.3 | 54.6 | 26.7 | 51.10 | 2.5 | FAS/FKS |
| 1-1-2 | NT | NT | 40.5 | 10 | NT | NT | 49.4 | 39.8 | 19.43 | 2.5 | FAS/FKS |
| 1-1-3 | NT | NT | 50.4 | 10 | NT | NT | 50.7 | 36.9 | 27.22 | 2.5 | FAS/FKS |
| 1-1-4 | NT | NT | 104.2 | 30 | NT | NT | 50.6 | 2.6 | 94.86 | 2.5 | FAS/FKS |
| 1-1-5 | NT | NT | 117.5 | 30 | NT | NT | 50.6 | 1.3 | 97.43 | 2.5 | FAS/FKS |
| 1-1-6 | 1.79 | 1.35 | 81.5 | 30 | 98.2 | 98.7 | 54.7 | 0.5 | 99.09 | 2.5 | FAS/FKS |
| 1-1-7 | NT | NT | 89.8 | 50 | NT | NT | 52.6 | 1.2 | 97.72 | 2.5 | FAS/FKS |
| 1-1-8 | 1.00 | 1.07 | 167.8 | 50 | 99.0 | 98.9 | 53.5 | 0.8 | 98.50 | 2.5 | FAS/FKS |
| 1-1-9 | 0.59 | 0.66 | 97.7 | 50 | 99.4 | 99.3 | 51.7 | 0.7 | 98.65 | 2.5 | FAS/FKS |
| 1-2-1 | NT | NT | 24.7 | 10 | NT | NT | 496 | 419.0 | 15.52 | 2.5 | FAS/FKS |
| 1-2-2 | 54.63 | 53.51 | 57.8 | 10 | 45.4 | 46.5 | 479 | 380.0 | 20.67 | 2.5 | FAS/FKS |
| 1-2-3 | NT | NT | 372.7 | 10 | NT | NT | 494 | 108.5 | 78.04 | 2.5 | FAS/FKS |
| 1-2-4 | NT | NT | 471.9 | 30 | NT | NT | 498 | 71.6 | 85.62 | 2.5 | FAS/FKS |
| 1-2-5 | NT | NT | 623.0 | 30 | NT | NT | 493 | 127.0 | 74.24 | 2.5 | FAS/FKS |
| 1-2-6 | 1.90 | 1.10 | 1542.2 | 30 | 98.1 | 98.9 | 442 | 3.7 | 99.16 | 2.5 | FAS/FKS |
| 1-2-7 | NT | NT | 485.3 | 50 | NT | NT | 489 | 3.9 | 99.20 | 2.5 | FAS/FKS |
| 1-2-8 | NT | NT | 809.6 | 50 | NT | NT | 500 | 1.1 | 99.78 | 2.5 | FAS/FKS |
| 1-2-9 | 0.51 | 0.40 | 1498.8 | 50 | 99.5 | 99.6 | 509 | 3.7 | 99.27 | 2.5 | FAS/FKS |
| 1-3-1 | 47.94 | 41.44 | 62.2 | 10 | 52.1 | 58.6 | 960 | 800.0 | 16.67 | 2.5 | FAS/FKS |
| 1-3-2 | NT | NT | 56.3 | 10 | NT | NT | 990 | 852.0 | 13.94 | 2.5 | FAS/FKS |
| 1-3-3 | 28.31 | 9.90 | 98.7 | 10 | 71.69 | 90.1 | 936 | 20.6 | 97.80 | 2.5 | FAS/FKS |
| 1-3-4 | NT | NT | 610.7 | 30 | NT | NT | 967 | 407.0 | 57.91 | 2.5 | FAS/FKS |
| 1-3-5 | 14.99 | 10.28 | 1042.6 | 30 | 85.0 | 89.7 | 967 | 22.2 | 97.70 | 2.5 | FAS/FKS |
| 1-3-5R | NT | NT | 1016.9 | 30 | NT | NT | 933 | 90.8 | 90.27 | 2.5 | FAS/FKS |
| 1-3-6 | NT | NT | 951.8 | 30 | NT | NT | 945 | 26.3 | 97.22 | 2.5 | FAS/FKS |
| 1-3-7 | NT | NT | 918.7 | 50 | NT | NT | 934 | 44.6 | 95.22 | 2.5 | FAS/FKS |
| 1-3-8 | NT | NT | 924.1 | 50 | NT | NT | 945 | 5.3 | 99.44 | 2.5 | FAS/FKS |
| 1-3-9 | 1.76 | 1.37 | 797.8 | 50 | 98.2 | 98.6 | 951 | 5.7 | 99.40 | 2.5 | FAS/FKS |
| 1-4-1 | NT | NT | 202.4 | 15 | NT | NT | 491 | 353.0 | 28.11 | 2.5 | FAS/Nafion |
| 1-4-1A | NT | NT | 86.9 | 5 | NT | NT | 486 | 450.0 | 7.41 | 2.5 | FAS/Nafion |
| 1-4-2 | NT | NT | 129.3 | 10 | NT | NT | 486 | 396.0 | 18.52 | 2.5 | FAS/Nafion |
| 1-4-3 | NT | NT | 224.6 | 10 | NT | NT | 486 | 261.0 | 46.30 | 2.5 | FAS/Nafion |
| 1-4-4 | NT | NT | 705.9 | 30 | NT | NT | 484 | 24.3 | 94.98 | 2.5 | FAS/Nafion |
| 1-4-5 | NT | NT | 606.2 | 30 | NT | NT | 490 | 24.3 | 95.04 | 2.5 | FAS/Nafion |
| 1-4-5A | NT | NT | 740.6 | 30 | NT | NT | 484 | 1.8 | 99.63 | 2.5 | FAS/Nafion |
| 1-4-6 | NT | NT | 750.4 | 30 | NT | NT | 484 | 0.9 | 99.81 | 2.5 | FAS/Nafion |
| 1-4-9 | 3.93 | 1.19 | 515.4 | 50 | 96.1 | 98.8 | 501 | 1.7 | 99.66 | 2.5 | FAS/Nafion |
| 1-5-1 | NT | NT | 64.2 | 10 | NT | NT | 493 | 474.0 | 3.85 | 3.2 | FAS/FKS |
| 1-5-2 | NT | NT | 861.9 | 30 | NT | NT | 497 | 181.2 | 63.54 | 3.2 | FAS/FKS |
| 1-5-3 | 13.17 | 4.53 | 889.6 | 50 | 86.8 | 95.5 | 512 | 7.1 | 98.61 | 2.3 | FAS/FKS |
| 1-6-1 | NT | NT | 105.6 | 10 | NT | NT | 488 | 467.0 | 4.30 | 4.0 | FAS/FKS |
| 1-6-2 | NT | NT | 752.3 | 30 | NT | NT | 510 | 500.0 | 1.96 | 4.0 | FAS/FKS |
| 1-6-3 | 33.28 | 11.72 | 1129.5 | 50 | 66.7 | 88.3 | 518 | 29.9 | 94.23 | 4.0 | FAS/FKS |
| 1-10-1 | NT | NT | 709.7 | 30 | NT | NT | 380 | 3.1 | 99.18 | 2.5 | FAS/FKS |
| 1-10-2 | NT | NT | 672.6 | 10 | NT | NT | 380 | 27.6 | 92.74 | 2.5 | FAS/FKS |
| 1-10-3 | NT | NT | 554.8 | 20 | NT | NT | 380 | 6.7 | 98.24 | 2.5 | FAS/FKS |
| 1-11-1 | NT | NT | 1074.8 | 30 | NT | NT | 387 | 32.8 | 91.52 | 2.5 | FAS/FKS |
| 1-11-2 | NT | NT | 913.8 | 30 | NT | NT | 387 | 3.7 | 99.04 | 2.5 | FAS/FKS |
| 1-11-3 | NT | NT | 662.2 | 30 | NT | NT | 387 | 1.9 | 99.51 | 2.5 | FAS/FKS |

NT = Not Tested

### Correlation of Salt and PFAS Removal

A key evaluation of this test involved valuating possible relationships between salt removal and PFOA and PFOS removal. FIG. 6 shows that there is a correlation between salt removal and PFOA/PFOS removal. Due to the focus on demonstrating removal, most of the removal results are greater than 95% for both PFOA/PFOS. Therefore, it is difficult to establish a clear correlation across the range of removals. The correlation is also impacted by analytical uncertainty. At salt removals above 95% and for conductivities between 50 and 500 μS/cm, total PFOA and PFOS removal is greater than 90 percent. For the 1000 μS/cm initial feed conductivity case and at salt removal above 95 percent, total PFOA and PFOS removal ranged from 70 to 99.5 percent.

### Operating Parameter Observations

Operating parameters impacting scale-up will include current density across the membrane and electrode surface area, and parameters related to module resistance that will impact energy costs. Resistance parameters primarily include operating voltage, total module thickness, Feed Chamber conductivity, and AEM/CEM Chamber conductivity. Voltage was found to directly impact cell resistance in that higher voltages increase electrolysis of water, increasing the ionic concentration with a corresponding increase in ion flux and a nonlinear reduction in solution resistance

### Current Density

The effective exposed surface (membrane and electrodes) of the tested AEC module was 74 cm². The average current over the MTS was 48 mA (average of run averages), with the highest test run value of 186.1 mA (Test 1-3-7 average current). The average current density was 6.49 Amps per square meter (A/m²), and the highest run average current density was 25.14 A/m².

During batch testing, initial currents were high, and as time progressed the current decreased in an exponential decay relationship over time. Due to a quickly dropping current it was difficult to read the initial instantaneous value. Initial recorded current averaged 194 mA (26.2 A/m²), with a single run maximum reading value of 667 mA (90.1 A/m²).

During testing, a run was attempted at 5 amps (676 A/m²); however, the AEM was destroyed at this current load.

### Electrode Separation Distance

Tests 1-5 and 1-6 were conducted to evaluate the effect of electrode separation distance on AEC performance. The effect is discussed further below. During the MTS electrode separation was constant at 2.5 cm.

### Module Electrical Resistance

Electrical resistance across the module averaged 1,987 ohms over the MTS, with a maximum of 7,576 ohm (Run 1-1-9). Overall module resistance was highest for the low salt content runs. Over the 50, 500, and 1000 uS/cm tests, overall module resistance averaged 3,389, 958, and 934 ohms, respectively. Additional discussion is provided herein.

### Total Current

Total current across the module averaged 480.1 mA-min over the MTS, with a maximum run average of 1,562 mA-min (Run 1-2-6). Total current was highest during the lowest salt content tests. Over the 50, 500, and 1000 uS/cm tests, total module current averaged 88.5, 662, and 700 mA-min, respectively.

On a per 1,000-gallon treated basis, the above translates to an average of 474 A-hr/1000 gallons over the MTS, with a maximum single run average of 1,542 A-hr/1000 gallons (Run 1-2-6). Total current was highest during the high salt content test. Over the 50, 500, and 1000 uS/cm tests, overall module resistance averaged 87.4, 663.6, and 691 A-hr/1000 gallons, respectively.

### Energy Consumption

Energy consumption during the testing was measured during testing using an ammeter installed in-line with the power supply and AEC module.

Total energy requirements averaged 17.52 KW-hr over the MTS, with a maximum of 75.91 KW-hr (Run 1-2-9). The overall energy requirement was highest during the high salt content run. Over the 50, 500, and 1000 uS/cm tests, AEC module energy requirements were 3.19, 25.14, and 24.6 KW-hr, respectively.

On a per 1,000-gallon treated basis, the above translates to an average of 17 KW-hr/1000 gallons over the MTS, with a maximum run average of 1,542 KW-hr/1000 gallons (Run 1-2-6). Overall current was highest over the high salt content test. Over the 50 500, and 1000 uS/cm tests, power requirements averaged 3.11, 24.51, and 23.98 KW-hr/1000 gallons, respectively.

### Activity I Analytical Quality Assurance

A number of QC (quality control) measures were implemented during testing to evaluate the quality of the test results. Sampling-specific measures included feed spike checks, reagent blanks, and equipment feed stock spikes.

An initial QC check suite of samples was submitted prior to the main Activity 1 sample submittal. Results are presented in Table 3-3.

TABLE 3-3
Activity I Analytical QC Results

| Run #/ | | PFOA | PFOS | | | % ¹³C | % ¹³C |
|---|---|---|---|---|---|---|---|
| Sample | UTK | Conc. | Conc. | ¹³C | ¹³C | PFOA | PFOS |
| ID | Label | (ppb) | (ppb) | PFOA | PFOS | Recovery | Recovery |
| 1-0-EB1 | BL2 | 112.24 | 40.94 | 1.49 | 1.14 | 149.23 | 113.57 |
| 1-0-TS1 | BL7 | 83.48 | 39.90 | 0.98 | DN | 97.91 | NA |
| 1-2-TS1 | BL24 | 79.69 | 29.33 | 0.65 | DNQ | 64.76 | NA |
| 1-3-9AEM | BL25 | 0.38 | 0.47 | 2.01 | 1.24 | 201.36 | 127.12 |

DNQ = laboratory did not quantify

Feed stock sample (1-0-EB1) was collected and analyzed to determine whether the concentration of PFOA/PFOS placed in the feed cell of the AEC would be impacted when allowed to remain in the AEC feed chamber for 20 minutes with no power. The results showed results reasonably consistent with 1-0-TS1 and 1-0-TS2, which were both spiked with 100 ppb of each PFOA and PFOS. This testing is significant because it showed that there was effectively no sorption onto the AEM over the 20-minute period of the test where there was no current flow through the cell.

A review of the Activity I analytical results showed PFAS ¹³C surrogate recoveries varied widely, with most outside the target recovery range. PFOA ¹³C recoveries ranged from 33.9 to 307 percent, and PFOS ¹³C recoveries ranged from 56.2 to 229 percent recovery.

Subsequently, four additional samples were prepared to evaluate this issue. They included two 100 ppb feed solutions (1-0-28 and 1-0-29), one 10 ppb feed solution (1-0-29), and Sample 1-0-30, a re-run of Sample 1-3-8AEM (AEM chamber concentrate). Results showed that a majority of the ¹³C spike recovery variability issue experienced with the Activity 1 samples appeared to have been due to the low spiking volume of 1 uL, which was increased to between 2 to 10 uL for supplemental samples. Supplemental sample analytical results are summarized in Table 3-4. The AEM sample was submitted to evaluate the fate of the PFAS, and showed a very low PFAS concentration.

TABLE 3-4
Supplemental Activity I Analytical QC Results-Activity I

| | | | | | 13C | 13C |
|---|---|---|---|---|---|---|
| | | Actual | | | PFOA | PFOS |
| | | (each | PFOA | PFOS | Recovery | Recovery |
| Sample | Description | ppb) | (ppb) | (ppb) | (%) | (%) |
| 1-0-28 | Feed | 100 | 51.97 | 46.79 | 43.64 | 34.18 |
| 1-0-29 | Feed | 100 | 51.76 | 48.59 | 45.99 | 35.23 |
| 1-0-31 | Feed | 10 | 12.13 | 10.02 | 80.39 | 72.82 |
| 1-0-30 | AEM | App. | 1.67 | 0.9 | 108.1 | 90.58 |
| | | 100 | | | | |

Results from Table 3-4 show the following:
The 100 ppb feed stock supplemental samples (1-0-28 and 1-0-29) were analyzed at 47-52 ppb for both PFOA and PFOS. If corrected for recoveries, the results are close to the actual 100 ppb spiked.
The 10 ppb feed stock was analyzed to be 12.13/10.02 ppb PFOA/PFOS. Results show good agreement with the actual feed stock.
Overall, the higher ¹³C spiking levels resulted in lower percent recovery variability than shown in Table 3-3.

The last sample (1-0-30) was the concentrate contained within the AEM-electrode chamber. This should have held the PFOA/PFOS mass transferred from the center feed chamber, and should have been at a PFOS concentration about the same as the test stock (TS) samples, between 40 to 50 ppb PFOA and PFOS (100 ppb each in actual feed). This analytical result was consistent with the previous anode chamber sample (Sample 1-3-8AEM), which was an identical run. It was believed that the PFOA/PFOS was either collecting on the electrode and/or the membrane, and not in the liquid. It was also thought that the PFOA/PFOS could be modified or degraded within the anode chamber. Because ¹³C recovery was good on this AEM liquid sample, there did not appear to be issues with the analytical process.

### Equipment Checks and Calibration

The primary test monitoring activities consisted of pH, conductivity, voltage, current, pH, mass, and conductivity measurement. The pH meter was calibration checked periodically using pH 4.01, 7.00, and 10.01 standards. The conductivity meter was initially calibrated and calibration checked using 23, 447, and 12,880 standards by Oakton and Atlas Scientific. Volt and current meters were checked by comparing results from multiple instruments. The current and voltage meters on the power supplies were found to be inaccurate, and test instruments were wired into the power supply circuit to obtain the correct current and voltage readings.

### PFAS Removal Findings

During Activity I both PFOA and PFOS were spiked into a sodium chloride and DI water solution each at 100 ppb, for a total of 200 ppb. Findings associated with the MTS performance are as follows:
The AEC is capable of removing a high percentage of the PFOA and PFOS from the Feed Chamber in a batch operating mode.
High feed PFOA/PFOS removal efficiencies are achievable over the range of salt concentrations tested (i.e., 50 to 1000 μS/cm).
Total and individual PFOA and PFOS removal can be approximated based on salt removal.
Module electrical resistance increases with reduced Feed Chamber concentration.
Removal efficiencies for both PFOA and PFOS are equivalent under the range of operating conditions tested.
The removal efficiency is dependent on total current transferred across the AEC, with higher removal experienced at higher total current (i.e., A-hr).
More current and total energy is required for the same total PFOA and PFOS removal at higher salt concentrations/conductivities.
Operation at high current density will destroy the AEM membrane.

### Other Findings

Other findings related to operation as follows:
AEM easily deformed during operation. The were no significant deformation issues with the CEM.
Removing the CEM (operating without CEM) caused destruction of the AEM. Therefore, for an effective AEC the use of both an AEM and CEM appear to be necessary.
During testing using a gold-plated anode, the gold eventually dissolved in the AEM Chamber during operation. A more durable anode will be required for subsequent testing and commercial operation. A platinum coating is frequently used in such applications.
Sediment accumulations were found after each test run inside the AEM Chamber. The CEM Chamber and CEM electrode appeared unaffected by the Activity I testing.
It was discovered that a planned methanol rinse of the membrane could not be used because the methanol dissolved the membrane. In lieu of a methanol rinse, a HPLC grade water rinse was used.
AEC can be used to produce water of DI water standards, which may also have commercial applications.

### Activity I (Batch Testing) Conclusions and Areas for Future Study

The results from Activity I demonstrated that the AEC can remove a high percentage of PFOA and PFOS from aqueous streams initially at 100 ppb (each). The power required to achieve the removal depends on the initial feed conductivity. At the lowest conductivity tested (50 uS/cm), less than 200 A-hr/1000 gallons were required to achieve PFOA/PFOS average removal greater than 98 percent. During testing where conductivity was 20 times higher, less than 800 A-hr/1000 gallons was required to achieve a PFOA/PFOS average of greater than 98 percent removal (about 4 times higher current).

### Flow-Through AEC Testing Results-Activity II

Activity II (flow through testing) was conducted subsequent to Activity I (batch testing). During Activity II, two PFAS feed concentrations were used for each PFOA and PFOS. These included 10 ppb and 2 ppb. These levels were considerably lower than the feed concentration of 100 ppb used in Activity I testing. The range of 2 to 100 ppb spans typical levels of industrial PFAS contamination.

### Description of AEC Module

In Activity II, the AEC module was configured the same size as in Activity I, but modified to allow flow-through operation. Key AEC modifications included adding flow connections between the three cells in each chamber, additional between-chamber flow paths, and gas vents.

### Flow-Through Testing Protocol

Flow-through testing involved operating the AEC over a range of feed salt concentrations, flow rates, voltages, and currents. Because the same AEC volume was used on all tests, the flow rate was proportional to the residence time. Electrical current was controlled by adjusting voltage to achieve a given feed outlet conductivity target value. Initial runs Test 2-0, Runs 1-11 were conducted to gain familiarity with the performance on the test solution, which consisted of sodium chloride mixed into DI water at concentrations of 75, 250, and 500 mg/L. During testing the conductivity was measured using a conductivity meter as uS/cm. Conductivity can be adjusted to mg/L NaCl by multiplying by a factor of 0.5.

Testing under the test matrix was conducted to obtain target salt removal of 40, 80, and greater than 98 percent in the outflow from the feed chamber.

### Modifications to Original Activity I Protocol

Modifications from the original test described earlier protocol are as follows:
It had originally been anticipated that two AEC modules would be required in series for the flow-through testing. It was found that project objectives could be met with a single AEC module.
One additional test was added (2-8, Runs 1-3) to allow performance evaluation at different residence times while operating at the same total current.
One additional test was added (2-9,Runs 1-3) to allow performance evaluation at a high AEM chamber concentration factor.
It had originally been anticipated that only three feed samples would be analyzed. It was decided to analyze each test's feed samples for use in removal calculations.
Feed concentrations were originally planned at 1 and 10 ppb. However, the low concentration was increased to 2 ppb to provide more definitive quantification at the analytical laboratory.
The original temperature range was expected to be 20 to 25° C. This was increased to 25 to 30° C. The low temperature test condition temperature was reduced from 15° C. to 4° C. to better show potential impact of temperature.

### Results

Results from the flow-through testing are presented for both PFAS removal and salt removal in the following text

### PFAS Removal Results

PFOA and PFOS results from the Activity II AEC testing are presented in Table 4-1. All Activity II tests were conducted at the same electrode spacing and using the same ion exchange membranes (FumaSep® membrane) as were used during Activity I.

Test results show effective removal of both PFOA and PFOS. The electrical current setting for each test was adjusted to achieve target removals of 40, 80, and greater than 98 percent salt removal. As noted in Activity I testing, above about 95% removal the removal curve flattens considerably with only small incremental gains in removal achieved with additional power input. Total PFOA and PFOS removal ranged from 95.6 to 98.7 percent when the AEC was operated to achieve better than 98% salt removal.

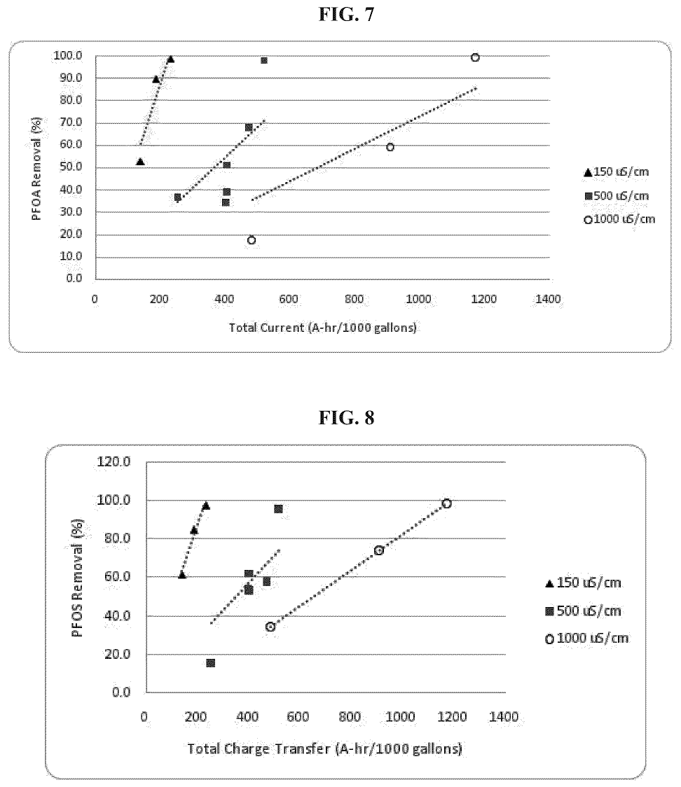

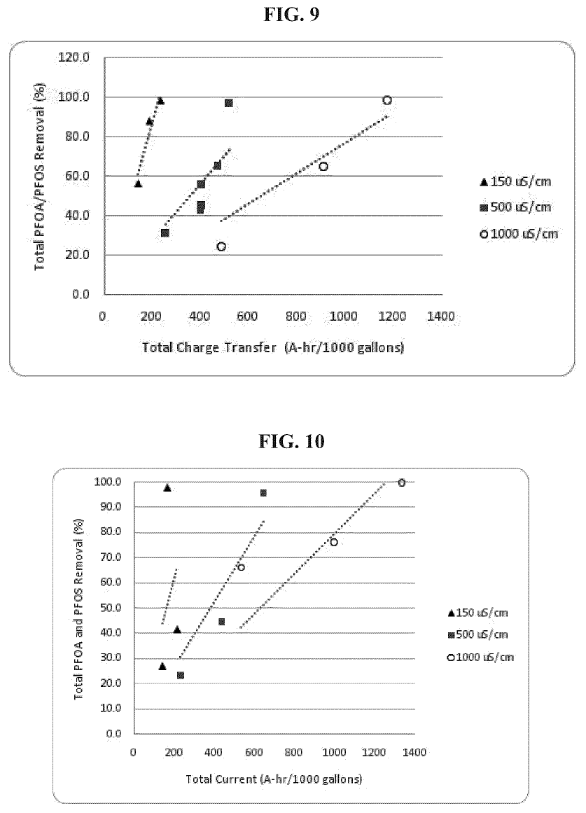

FIG. 7 shows how PFOA removal varied with total current (electrical charge transfer through AEC) at 10 ppb of PFOA initially in the feed. FIG. 8 is the same chart for PFOS at a feed concentration of 10 ppb of each PFAS initially in the feed. The charts show nearly identical performance for PFOA and PFOS removal. FIG. 9 presents total PFOA and PFOS removed. The trend lines in these graphs is plotted through zero to simplify interpretation of trends.

TABLE 4-1
PFAS and Salt Removal Results-Activity II

| | | | Total | Feed | | | | Total | Initial | Final | | | |
|---|---|---|---|---|---|---|---|---|---|---|---|---|---|
| | Treated | Treated | Current | Resi- | | PFOA | PFOS | PFAS | Feed | Treated | Salt | Elec- | |
| | PFOA | PFOS | (A- | dence | | Re- | Re- | Re- | Cond. | Cond. | Re- | trode | |
| Test/ | Conc. | Conc. | hr/1000 | Time | Volts | moval | moval | moval | (uS/ | (uS/ | moval | Spacing | AEM/ |
| Run | (ppb) | (ppb) | gal) | (seconds) | (V) | (%) | (%) | (%) | cm) | cm) | (%) | (cm) | CEM |
| 2-1-TS | 14.11 | 10.26 | — | — | — | — | — | — | — | — | — | — | — |
| 2-2-TS | 2.038 | 1.166 | — | — | — | — | — | — | — | — | — | — | — |
| 2-3-TS | 14.07 | 7.74 | — | — | — | — | — | — | — | — | — | — | — |
| 2-4-TS | 1.905 | 0.745 | — | — | — | — | — | — | — | — | — | — | — |
| 2-5-TS | 14.97 | 7.9 | — | — | — | — | — | — | — | — | — | — | — |
| 2-6-TS | 1.954 | 1.208 | — | — | — | — | — | — | — | — | — | — | — |
| 2-7-TS | 7.995 | 5.04 | — | — | — | — | — | — | — | — | — | — | — |
| 2-8-TS | 14.76 | 10.43 | — | — | — | — | — | — | — | — | — | — | — |
| 2-9-TS | 14.76 | 10.43 | — | — | — | — | — | — | — | — | — | — | — |
| 2-0-EB | 0.01 | 0.05 | — | — | — | — | — | — | — | — | — | — | — |
| 2-1-1 | 11.67 | 6.73 | 467.3 | 12.09 | 13.2 | 17.29 | 34.41 | 24.5 | 963 | 484 | 49.74 | 2.5 | FAS/FKS |
| 2-1-2 | 5.82 | 2.64 | 876.3 | 12.09 | 26.4 | 58.75 | 74.27 | 65.3 | 963 | 150 | 84.42 | 2.5 | FAS/FKS |
| 2-1-3 | 0.12 | 0.13 | 1133.3 | 12.09 | 62.2 | 99.15 | 98.73 | 99.0 | 963 | 0.9 | 99.91 | 2.5 | FAS/FKS |
| 2-2-1 | 0.687 | 0.622 | 515.0 | 13.33 | 13 | 66.29 | 46.66 | 59.1 | 947 | 548 | 42.13 | 2.5 | FAS/ |
| | | | | | | | | | | | | | Nafion |
| 2-2-2 | 0.488 | 0.255 | 965.7 | 13.33 | 25 | 76.05 | 78.13 | 76.8 | 947 | 99 | 89.55 | 2.5 | FAS/FKS |
| 2-2-3 | 0.009 | 0.025 | 1287.6 | 13.33 | 113.3 | 99.56 | 97.86 | 98.9 | 947 | 6 | 99.37 | 2.5 | FAS/FKS |
| 2-3-1 | 10.78 | 6.66 | 225.3 | 5.83 | 40 | 23.38 | 13.95 | 20.0 | 490 | 313.5 | 36.02 | 2.5 | FAS/FKS |
| 2-3-2 | 7.8 | 3.79 | 422.5 | 5.83 | 75 | 44.56 | 51.03 | 46.9 | 490 | 202 | 58.78 | 2.5 | FAS/FKS |
| 2-3-3 | 0.59 | 0.38 | 622.5 | 5.83 | 110.5 | 95.81 | 95.09 | 95.6 | 490 | 1.65 | 99.66 | 2.5 | FAS/FKS |
| 2-4-1 | 1.203 | 0.628 | 243.8 | 6.31 | 15.8 | 36.85 | 15.70 | 30.9 | 490 | 253 | 48.37 | 2.5 | FAS/FKS |
| 2-4-2 | 0.608 | 0.315 | 455.7 | 6.31 | 28.1 | 68.08 | 57.72 | 65.2 | 490 | 40.7 | 91.69 | 2.5 | FAS/FKS |
| 2-4-3 | 0.035 | 0.033 | 500.8 | 6.31 | 62.43 | 98.16 | 95.57 | 97.4 | 490 | 3.4 | 99.31 | 2.5 | FAS/FKS |
| 2-5-1 | 10.94 | 5.44 | 137.0 | 1.87 | 76 | 26.92 | 31.14 | 28.4 | 157 | 128.9 | 17.90 | 2.5 | FAS/FKS |
| 2-5-2 | 8.73 | 5.43 | 207.3 | 1.87 | 115 | 41.68 | 31.27 | 38.1 | 157 | 82.35 | 47.55 | 2.5 | FAS/FKS |
| 2-5-3 | 0.31 | 0.15 | 162.7 | 1.87 | 90 | 97.93 | 98.10 | 98.0 | 151 | 0.7 | 99.54 | 2.5 | FAS/FKS |
| 2-6-1 | 0.921 | 0.465 | 134.0 | 1.85 | 75 | 52.87 | 61.51 | 56.2 | 150 | 51.4 | 65.73 | 2.5 | FAS/FKS |
| 2-6-2 | 0.181 | 0.200 | 178.7 | 1.85 | 100 | 89.76 | 85.02 | 88.0 | 150 | 17.6 | 88.27 | 2.5 | FAS/FKS |
| 2-6-3 | 0.024 | 0.028 | 223.4 | 1.85 | 125 | 98.77 | 97.68 | 98.4 | 150 | 1.6 | 98.93 | 2.5 | FAS/FKS |
| 2-7-1 | 5.709 | 3.249 | 487.8 | 6.73 | 75 | 28.59 | 35.48 | 31.3 | 489 | 254.5 | 47.96 | 2.5 | FAS/FKS |
| 2-7-2 | 3.487 | 1.829 | 650.4 | 6.73 | 100 | 56.39 | 63.68 | 59.2 | 489 | 95.55 | 80.46 | 2.5 | FAS/FKS |
| 2-7-3 | 0.289 | 0.191 | 813.0 | 6.73 | 125 | 96.39 | 96.21 | 96.3 | 489 | 3.65 | 99.25 | 2.5 | FAS/FKS |
| 2-8-1 | 8.96 | 4.84 | 388.6 | 13.06 | 30.8 | 39.30 | 53.60 | 45.2 | 491 | 144 | 70.67 | 2.5 | FAS/FKS |
| 2-8-2 | 9.65 | 4.78 | 386.7 | 6.53 | 61.3 | 34.62 | 54.17 | 42.7 | 491 | 154 | 68.64 | 2.5 | FAS/FKS |
| 2-8-3 | 7.18 | 3.97 | 199.4 | 1.87 | 215.7 | 51.36 | 61.94 | 55.7 | 491 | 117 | 76.17 | 2.5 | FAS/FKS |

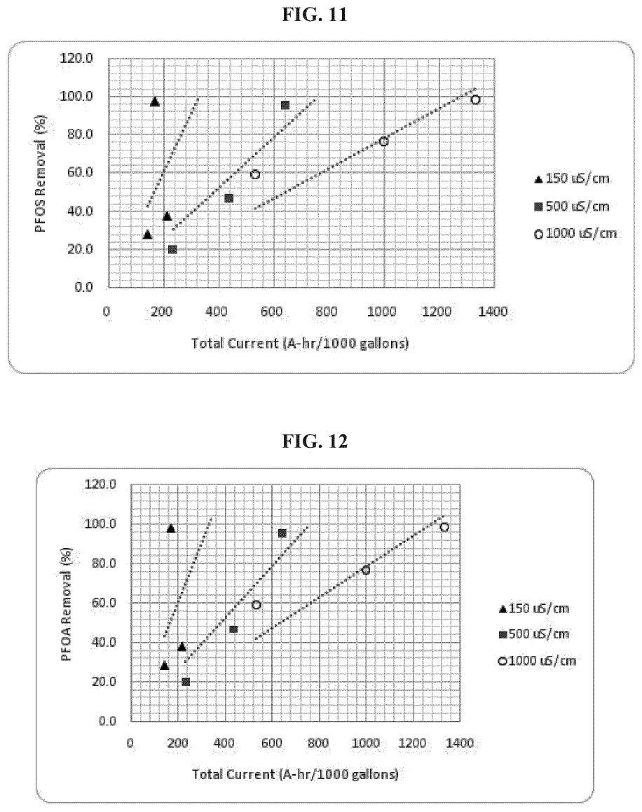

FIG. 10 shows how PFOA removal varied with total current at 2 ppb of each PFAS in the feed. FIG. 11 present the same information but for PFOS at a feed concentration of 2 ppb. The charts show nearly identical removal for PFOA and PFOS. FIG. 12 is the same chart for both PFOA and PFOS combined.

The results from FIGS. 7-12 were compared with regard to achieving a target value of 0.070 ppb total PFOA and PFOS in the treated water. At 10 ppb feed, the required removal is 99.3 percent, and at 2 ppb the required removal is 96.5 percent. Table 4-1 provides an estimate of expected total current required to achieve the target final concentration value. The results suggest that between 4 to 40 percent more total current is required to achieve the same removal result at 2 ppb as opposed to 10 ppb feed concentration.

TABLE 4-2
Total Current to Achieve 70 ppt Target

| | Feed | Feed | |
|---|---|---|---|
| Feed | Concentration | Concentration | |
| Conductivity | 10 ppb | 2 ppb | |
| (uS/cm) | (A-hr/1000 gal) | (A-hr/1000 gal) | Ratio |
| 150 | 240 | 320 | 1.33 |
| 500 | 520 | 730 | 1.40 |
| 1000 | 1,190 | 1,240 | 1.04 |

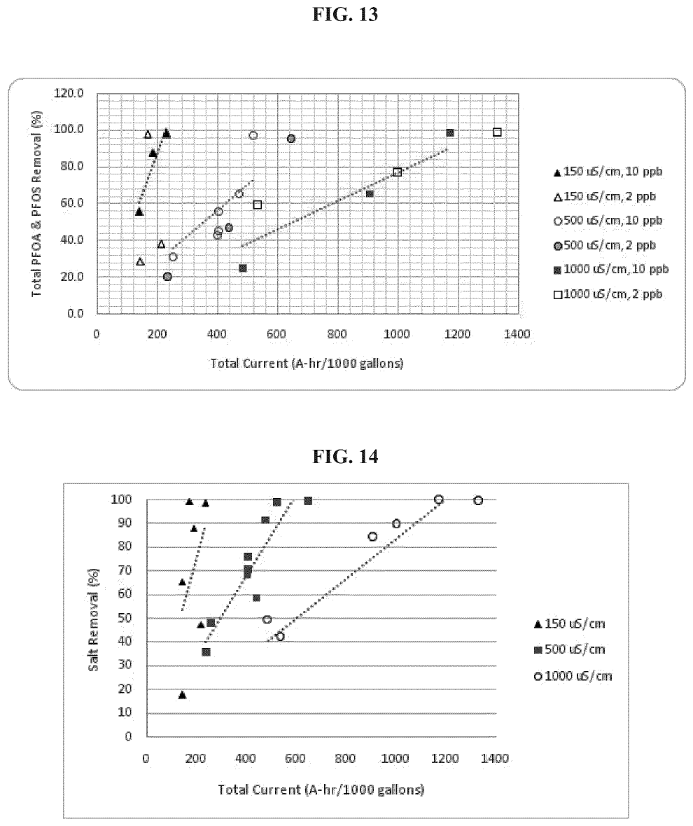

Total PFOA and PFOS removal at 2 ppb and 10 ppb is plotted against total current in FIG. 13.

### Salt Removal Results

Salt removal results are summarized in Table 4-1 for all of the Activity II testing. The correlation between total current and salt removal follows a pattern very similar to that of the tested PFAS as shown in FIG. 14.

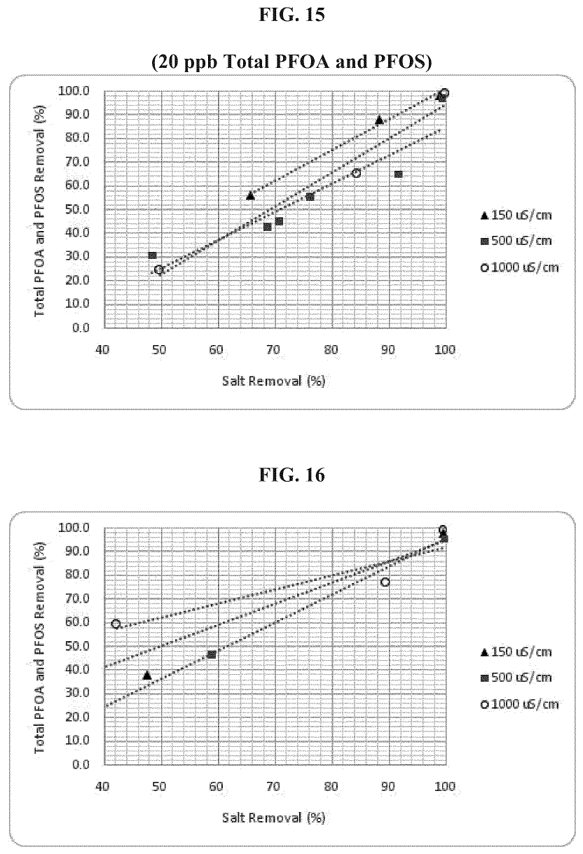

FIGS. 15 and 16 show PFOA and PFOS removal as a function of salt removal. The correlation is strong enough to make approximate estimates of PFAS removal at a given percentage salt removal.

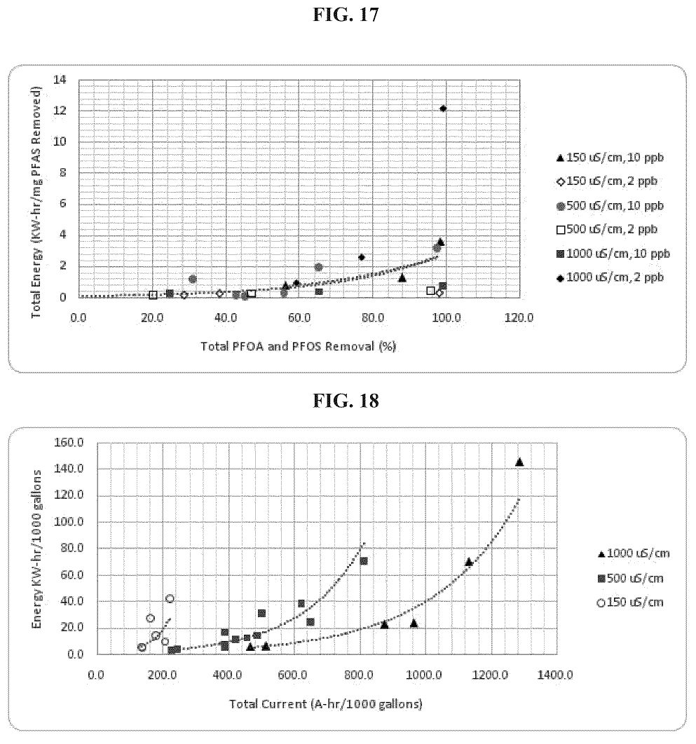

FIG. 17 is a plot of total energy requirements per unit mass (PFOA and PFOS) removed, as related to percentage total PFOA and PFOS removal.

### Relationship Between Total Current and Required Energy

Within the AEC there are a number of operating parameters interacting both independently and between parameters that govern the total energy requirement for a given total current. The primary factor influencing required energy is the inlet feed conductivity, which is shown in FIG. 18. As shown in the chart significantly more energy is required at lower concentrations at the same total current requirement.

### Other Testing

In addition to the MTS, other operating conditions were evaluated to gain additional insight with respect to a specific operating parameter.

The primary data set evaluated included Runs 2-1 through 2-6 which represent the MTS for Activity II testing. Other evaluations outside the main data set and are discussed further in later discussion. These tests included the following:
Test 2-7 Evaluated the effect of lower temperature on performance
Test 2-8 Evaluated the effect of feed chamber flow rate (i.e., velocity) on performance
Test 2-9 Evaluated the effect of higher AEM and CEM chamber conductivities on performance
Test 2-0-16 Evaluated fate of tested PFAS in the AEM and CEM chambers

Test 2-7 was conducted with a feed temperature of around 4° C. and at conditions that allowed comparison to Test 2-4. Test 2.8 was conducted by holding the total current at near 400 A-hr/1000 gallons, while operating at different feed rates. Test 2-9 was conducted by increasing the ratio between the feed rate and AEM/CEM flow rates, to produce a higher concentration factor. Test 2-0-16 was conducted to evaluate the fate of PFAS in the AEM chamber. This test was conducted by duplicating earlier tests, and starting with a feed concentration of 1,000 ppb of each PFOA and PFOS. The resulting samples were analyzed for potential degradation products. Additionally, a fluorine analysis was conducted.

### MTS Operating Parameters and Observations

The primary operating conditions monitored during the test program included conductivity, temperature, pH, voltage, current, and the flow rate in each chamber.

### Current Density

The effective exposed surface (individual membrane and electrode-single exposed surface) of the tested AEC module was 74 cm², the same as in Activity I testing. The average current over the MTS was 79.5 mA (average of run averages), with the highest run value of 125 mA (Test 2-6-3). The average current density was 1.07 mA/cm², with a maximum current density of 1.69 mA/cm². The highest current and current density of all the test runs was 215.7 mA, and 2.91 mA/cm², respectively. Variations of current densities outside these ranges is allowable.

### Module Electrical Resistance

Electrical resistance across the module averaged 590 ohm over the MTS, with a minimum test run average of 330 ohm (Run 2-1-1), and a maximum single run average of 1,133 ohm (Run 2-2-3). Additional discussion of electrical resistance is provided elsewhere.

### Total Current

The total current passed through the AEC module averaged 512.1 A-hr/1000 gal., with a minimum test run average of 138.7 A-hr/1000 gal. and a maximum test run average of 1,332.7 A-hr/1000 gal.

### Total Energy Consumption

Energy consumption averaged 25.9 KW-hr per 1000 gallons (KW-hr/1000 gal.) over the MTS. The highest single run energy consumption was 145.9 KW-hr/1000 gal (Run 2-2-3) and the lowest was 3 KW-hr/1000 gal (Run 2-3-1). Over the 150, 500, and 1000 uS/cm conductivity tests, the required energy averaged 17.5, 16.8, and 46.1 KW-hr/1000 gallons.

### AEC Flow Rates Feed Flow Rate

Feed flow through the AEC system was conducted at 5, 10, and 35 mL/min over the Activity II testing program. Actual AEM and CEM chamber flows ranged from 4.9 to 35.3 mL/min. AEM and CEM chamber flow rates were maintained close to the same flow rates. Over the MTS the AEM and CEM flows averaged 4.1 mL/min and 4.2 mL/min, respectively.

During testing a vent port was placed in the AEM chamber to handle gas generation. An extra port was not required on the CEM chamber. There was no quantification of gas generation rate from the AEC. Gas generation will be a consideration in scale up and can be calculated based on the rate of water hydrolysis and cell efficiency using Faraday's Law.

### AEM and CEM Chamber Conditions

During the MTS the anode pH ranged from 2 to 2.8, and the cathode 10.9 to 12. Conductivity in the AEM ranged from 1,431 to 3530 uS/cm, and 937 to 3257 in the CEM. The Activity II MTS conductivity averages for the AEM and CEM were 2,412 and 1,819 uS/cm, respectively.

### Activity II Quality Assurance

A number of QC measures were implemented during Activity II testing to evaluate the quality of the results. Sample-specific measures included use of an equipment blank, and the analysis of more feed solution samples than originally planned. The additional feed samples were collected due to the low surrogate recoveries experienced in Activity I to provide a more consistent comparison between inlet and outlet concentrations.

The primary quality measure used to evaluate analytical results was ¹³C surrogate recoveries. These isotopically labeled surrogates were added after the samples were received at the testing facility, but before concentration and analysis. Prior to sample submittal to the laboratory samples were stored in a refrigerator at 6°° C., preserved with Trizma®, and transferred to the testing facility in coolers on ice.

The surrogate recoveries for Activity II testing are summarized in Table 4-3. Depending on the test feed stock either 10 uL or 2 uL of ¹³C labeled compound was added.

TABLE 4-3
Surrogate Recoveries-Activity II PFAS Analyses

| Run #/ | | PFOA | PFOS | ¹³C PFOA | ¹³C PFOS | % ¹³C | % ¹³C |
|---|---|---|---|---|---|---|---|
| Sample | UTK | Conc. | Conc. | Recovered | Recovered | PFOA | PFOS |
| ID | Label | (ppb) | (ppb) | (ppb) | (ppb) | Recovery | Recovery |
| 2-1-TS | BL49 | 14.11 | 10.26 | 8.62 | 5.58 | 86.3 | 55.8 |
| 2-2-TS | BL 69 | 2.038 | 1.166 | 5.89 | 4.6 | 58.89 | 45.96 |
| 2-3-TS | BL 50 | 14.07 | 7.74 | 9.13 | 5.58 | 91.3 | 55.8 |
| 2-4-TS | BL 70 | 1.905 | 0.745 | 6.04 | 4.72 | 60.41 | 47.20 |
| 2-5-TS | BL 51 | 14.97 | 7.90 | 8.64 | 5.48 | 86.38 | 54.8 |
| 2-6-TS | BL 71 | 1.954 | 1.208 | 6.19 | 4.61 | 61.91 | 46.10 |
| 2-7-TS | BL 72 | 7.995 | 5.036 | 4.96 | 3.85 | 49.64 | 38.52 |
| 2-8-TS | BL 52 | 14.76 | 10.43 | 8.48 | 5.54 | 84.84 | 55.4 |
| 2-9-TS | BL 73 | 7.272 | 4.734 | 4.66 | 3.87 | 46.58 | 38.66 |
| 2-1-1 | BL-53 | 11.67 | 6.73 | 10.14 | 6.46 | 101.41 | 64.59 |
| 2-1-2 | BL-54 | 5.82 | 2.64 | 10.55 | 6.67 | 105.54 | 66.69 |
| 2-1-3 | BL 55 | 0.12 | 0.13 | 12.03 | 7.44 | 120.33 | 74.42 |
| 2-2-1 | BL 74 | 0.687 | 0.622 | 6.45 | 4.74 | 64.53 | 47.39 |
| 2-2-2 | BL 75 | 0.488 | 0.255 | 6.53 | 4.90 | 65.25 | 48.99 |
| 2-2-3 | BL 76 | 0.009 | 0.025 | 6.83 | 5.00 | 68.31 | 49.97 |
| 2-2-AEM | BL 89 | 0.006 | 0.018 | 6.56 | 4.77 | 65.56 | 47.74 |
| 2-2-AEM1 | BL 94 | 0.003 | 0.012 | 5.60 | 3.76 | 56.05 | 37.55 |
| 2-2-AEM2 | BL 90 | 0.002 | 0.017 | 6.42 | 4.73 | 64.20 | 47.26 |
| 2-3-1 | BL 56 | 10.78 | 6.66 | 9.14 | 5.90 | 91.37 | 58.98 |
| 2-3-2 | BL 57 | 7.8 | 3.79 | 10.15 | 6.45 | 101.55 | 64.50 |
| 2-3-3 | BL 58 | 0.59 | 0.38 | 12.07 | 7.18 | 120.66 | 71.84 |
| 2-4-1 | BL 77 | 1.203 | 0.628 | 6.11 | 4.32 | 61.12 | 43.18 |
| 2-4-2 | BL 78 | 0.608 | 0.315 | 7.01 | 5.05 | 70.11 | 50.50 |
| 2-4-3 | BL 79 | 0.035 | 0.033 | 6.12 | 5.16 | 61.22 | 51.59 |
| 2-5-1 | BL 59 | 10.94 | 5.44 | 9.60 | 6.12 | 95.96 | 61.24 |
| 2-5-2 | BL 60 | 8.73 | 5.43 | 9.72 | 6.08 | 97.18 | 60.76 |
| 2-5-3 | BL 61 | 0.31 | 0.15 | 12.15 | 7.41 | 121.53 | 74.14 |
| 2-6-1 | BL 80 | 0.921 | 0.465 | 6.07 | 4.54 | 60.67 | 45.39 |
| 2-6-2 | BL 81 | 1.181 | 0.200 | 8.03 | 5.15 | 80.31 | 51.55 |
| 2-6-3 | BL 82 | 0.024 | 0.028 | 8.04 | 4.70 | 80.40 | 47.01 |
| 2-7-1 | BL 83 | 5.709 | 3.249 | 5.29 | 3.76 | 52.89 | 37.56 |
| 2-7-2 | BL 84 | 3.487 | 1.829 | 5.51 | 4.19 | 55.06 | 41.89 |
| 2-7-3 | BL 85 | 0.289 | 0.191 | 6.78 | 5.02 | 67.84 | 50.21 |
| 2-8-1 | BL 62 | 8.96 | 4.84 | 10.03 | 6.39 | 100.25 | 63.90 |
| 2-8-2 | BL 63 | 9.65 | 4.78 | 10.03 | 6.34 | 100.30 | 63.42 |
| 2-8-3 | BL 64 | 7.18 | 3.97 | 10.54 | 6.42 | 105.45 | 64.18 |
| 2-8AEM1 | BL 65 | 0.01 | 0.03 | 10.45 | 6.91 | 104.46 | 69.11 |
| 2-8-CEM2 | BL 96 | 0.009 | 0.02 | 5.03 | 3.59 | 50.27 | 35.89 |
| 2-8AEM3 | BL 67 | 0.01 | 0.03 | 11.98 | 7.31 | 119.82 | 73.10 |
| 2-0-EB | BL 68 | 0.01 | 0.05 | 12.37 | 7.50 | 123.72 | 74.97 |
| 2-9-1 | BL 86 | 5.831 | 3.506 | 5.21 | 3.71 | 52.09 | 37.09 |
| 2-9-2 | BL 87 | 2.817 | 1.642 | 5.82 | 4.16 | 58.20 | 41.59 |
| 2-9-3 | BL 88 | 0.650 | 0.376 | 6.39 | 4.54 | 63.86 | 45.41 |
| 2-9-AEM | BL 91 | 0.002 | 0.018 | 6.3 | 4.63 | 62.99 | 46.27 |
| 2-9-AEM2 | BL 92 | 0.007 | 0.019 | 6.54 | 4.68 | 65.36 | 46.83 |
| 2-9-CEM | BL 93 | 0.005 | 0.019 | 6.69 | 4.62 | 66.90 | 46.15 |

Recoveries for PFOA were much higher than those of PFOS. The average recovery for PFOA was 80.07 percent with a range of 46.58 to 123.72 percent. The average recovery for PFOS was 53.69 percent with a range of 35.89 to 35.89. The testing facility laboratory indicated that PFOS has more interaction with surfaces than PFOA and is more prone to losses in the analytical process.

An equipment blank was prepared by placing DI water in the feed cell and removing it as a sample. The results were 0.01 ppb PFOA and 0.05 PFOS. These values are low relative to the objectives of the test.

As previously noted, feed samples from each test were analyzed. Feed surrogate recoveries for PFOA averaged 72.5 percent and 82.3 percent for treated samples. The difference in recoveries suggest that PFOA removal percentages are biased slightly lower than actual. PFOS surrogate recoveries averaged 48.7 percent and 54.7 percent. This would suggest an overall slightly higher bias to removal results. This also suggests that PFOS removals are biased slightly lower than actual. Overall the results suggest that on a total mass basis 82.3% of the actual PFOA and 54.7 percent of the actual PFOS in treated samples is being reported, presenting an overall low concentration bias.

### Equipment Checks and Calibration

The primary test monitoring parameters included pH, conductivity, voltage, current, pH, conductivity, and mass. Calibration was checked as described herein.

### PFAS Removal Findings

Findings from Activity II of the MTS are summarized below. Additional findings for other specific tests outside the MTS are described in Section 5.0.
The AEC is capable of removing a high percentage of the PFOA and PFOS from the Feed Chamber in the flow-through operating mode.
Total and individual PFOA and PFOS removal can be reasonably predicted based on salt removal in the flow-through operating mode.
Module electrical resistance increases with reduced feed chamber concentration in the flow through operating mode. This same correlation was observed in the batch testing.
There is a correlation of salt removal and PFOA and PFOS removal, as a linear function, with higher PFOA and PFOS removal achieved at a lower feed salt content.
Removal efficiencies for both PFOA and PFOS were equivalent under the range of operating conditions tested.
The removal efficiency is dependent on total current transferred across the AEC, with higher removal experienced at higher total current (i.e., A-hr).
More current and total energy is required for the same total PFOA and PFOS removal at higher salt concentrations/conductivities.
Between 4 and 30 percent more energy is required to remove total PFOA and PFOS when the initial feed concentration is 2 ppb as opposed to 10 ppb.
In comparing batch and flow-through testing results, batch operation requires lower current and energy than the flow-through mode for a given percentage PFOA and PFOS removal.

### Other Observations and Findings

Other findings related to the MTS are as follows:
When the AEC was operated without spacers inside the chamber, the AEM membrane deformed significantly to the point of causing membrane damage.
Anode vent off-gassing was significant, and approximately equal in volume to the side chamber feed rate. Off gassing was not quantified.
A white sediment was formed in the AEM chamber during all runs, and was found through analysis to consist primarily of titanium. The next generation of AEC will require use of a more durable anode electrode.
During testing it was observed that the AEM and CEM chamber pH steadily became more extreme to a point, at which time the pH stabilized, typically around 2 pH (AEM chamber), and 11.5 (CEM chamber). The same stabilization effect was also observed with conductivity.

### Activity II Conclusions

The results from Activity II demonstrated that the AEC, when operated in flow-through mode can remove a high percentage of PFOA and PFOS from aqueous streams initially at 2 and 10 ppb. The total current transfer required to achieve the removal depends on the initial feed conductivity, with higher current transfer requirements for higher initial salt concentration feeds. Additionally, PFOA and PFOS removal can be predicted by salt removal.

### Activity I AEC Resistance as Related to Feed Conductivity—Conductivity Impact

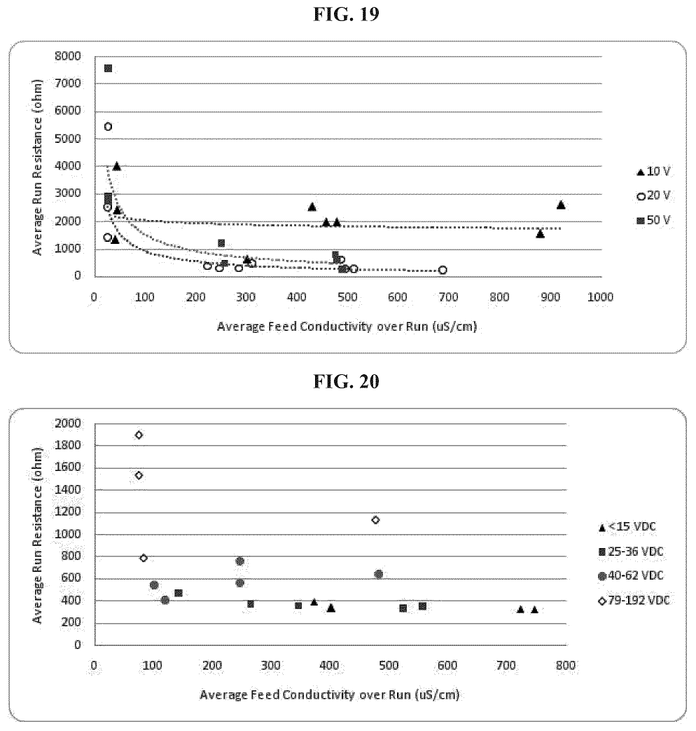

The effective AEC cell electrical resistance was calculated from measured current and voltage over each test run of the MTS. Average test cell resistance for the Activity I batch runs is presented in FIG. 19 as a function of average feed water conductivity, and at different treatment voltages. Specifically, the average run resistance is plotted against the average of the initial feed concentration and final concentration after treatment. The results show a trend of lower average resistance with an increase in average feed conductivity; although the effect is diminished at a a conductivity above 50 μS/cm. Also shown is lower resistance with higher treatment voltage.

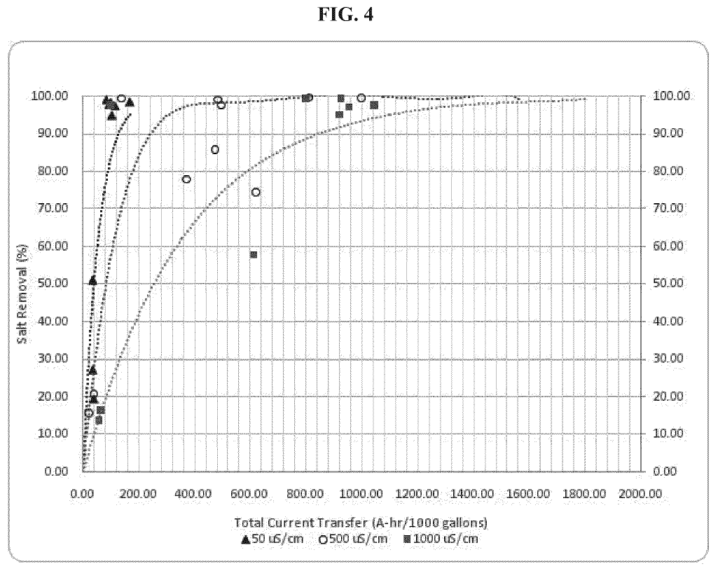

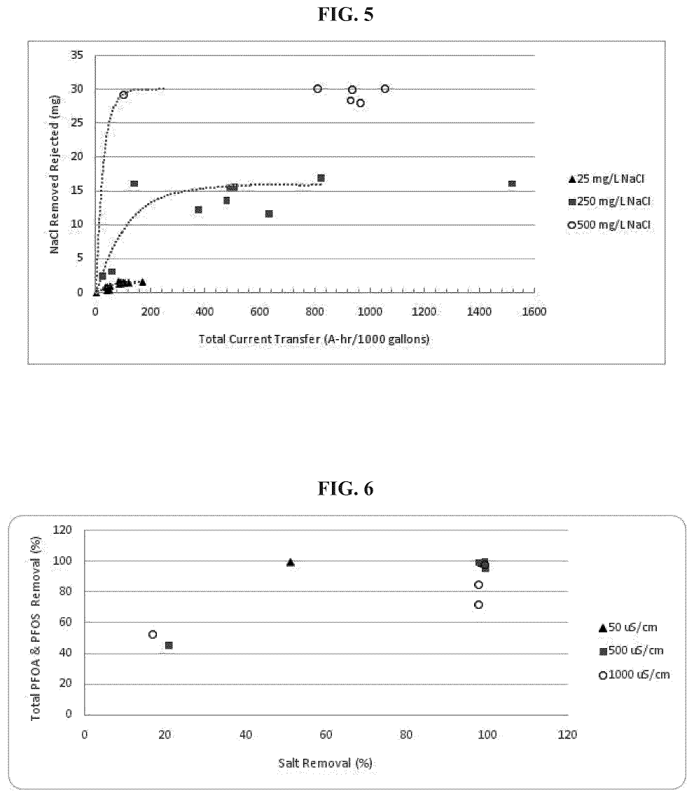

The same graph was prepared for Activity II results and is presented in FIG. 20. Activity II results show the same general trend of lower average resistance with an increase in average feed conductivity; however, the results suggest an inverted voltage effect as compared to Activity I resistance results. The trend shows a diminished impact of average feed conductivity above 100 μS/cm, similar to that observed in Activity I (FIG. 5-1). The correlation of resistance with treatment voltage does not appear as strong with the flow-through runs as compared to the batch results, although as previously noted both graphs show a sharp spike in resistance at low feed conductivities.

Overall resistance was considerably lower over the flow-through test, as compared to the batch test. This difference is likely due to the longer overall residence times in Activity I that resulted in more time operating during the low feed conductivity period later in the test runs.

### Electrode Resistance and Surface Area

A test, not specifically related to AEC testing was conducted to evaluate the effect of exposed electrode surface area on cell electrical resistance. In the test, a 3-inch wide Grade 2 titanium plate was immersed in a 1,530 uS/cm sodium chloride solution at a 1.2-inch plate separation. There was no mixing of the liquid contents. Results, presented in FIG. 22 show a non-linear reduction in cell resistance as the exposed surface area increases. As observed in FIG. 19, resistance is lower at higher operating voltage, likely due to localized increased ionic strength between the plates caused by ions generated through hydrolysis, which would increase at the higher voltages.

The AEC module used during testing had an effective area of 11.32 in². The plot in FIG. 22 shows that at a larger commercial system's surface area, resistance would be reduced by a factor of about 2 times, due solely to the increased surface area.

### Electrical Resistance and Electrode Spacing

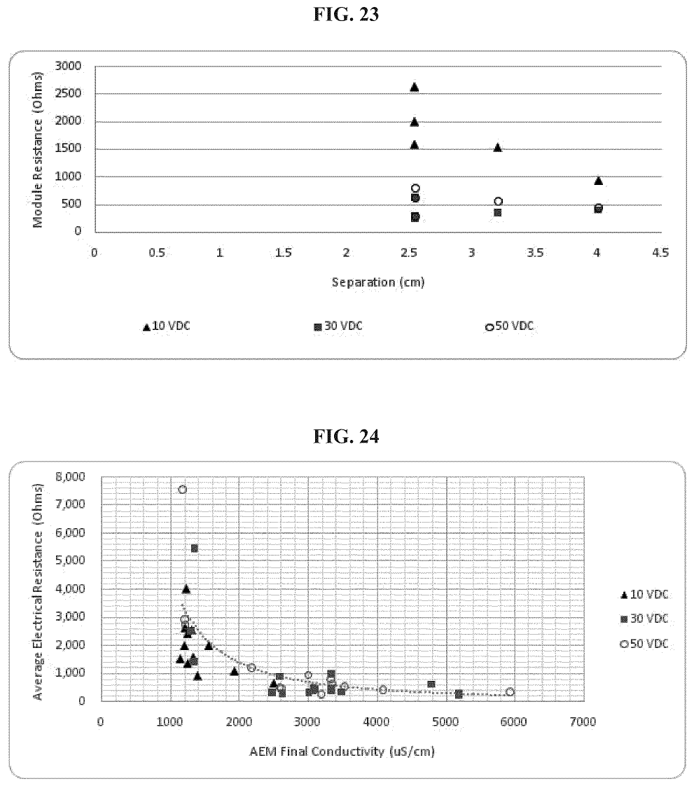

In Activity I, Tests 5 and 6, the feed chamber thickness was increased. This had the effect of changing the separation distance from 2.5 cm (MTS) to 3.2 cm (Test 5), and 4.0 cm (Test 6). These increased spacing tests were conducted at 250 mg/L NaCl, and results are shown in FIG. 23. The chart shows the same general trend of higher resistance at lower voltage as observed in FIG. 19. The chart also suggests decreasing resistance with increased electrode separation distance. There was not a similar test associated with Activity II. The next generation of AEC in the scale-up process will need to include a flow-through evaluation of electrode separation distance and Feed Chamber thickness to provide a conclusive finding relative to the impact of electrode spacing on electrical resistance.

### Membrane Chamber Ion Accumulation

Several tests were conducted during Activity I to evaluate the impact of conductivity in the side chambers on overall AEC electrical resistance. As shown in FIG. 24, the AEC electrical resistance is correlated with the final conductivity in the AEM chamber. The same relationship would hold for the CEM chamber conductivity, which correlates proportionally with AEM chamber conductivity. FIG. 24 shows that below about 1,500 uS/cm AEM conductivity, AEC cell resistance can become quite high. Above 1,500 uS/cm the electrical resistance of the cell slowly falls with increasing AEM chamber final conductivity. In the test series the side chamber stream to the middle was initially at 200 uS/cm.

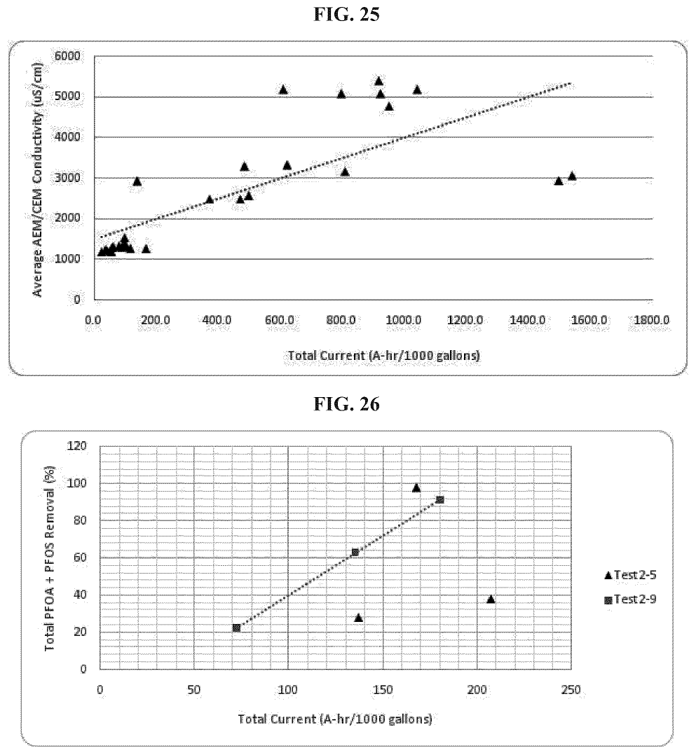

FIG. 25 shows that average AEM/CEM conductivity increases with total electrical current transferred across the AEC.

### Estimation of AEC Cell Average Resistance

The key operating parameters for the Activity I MTS were evaluated using multiple linear regression. As previously shown, there is a correlation between a number of operating parameters and AEC resistance. However, the overall correlation coefficient for parameters of statistical significance is low, at 0.45. The resulting equation is:

$$Resistance ( ohm ) = 51.889 \times ( Volts ) - 0.8918 \times ( AEM Cond . uS / cm ) + 2477.1$$

This equation will provide a reasonable approximation of the AEC cell resistance for the Batch testing in Activity I.

The same evaluation was performed for Activity II MTS results. The adjusted correlation coefficient is 0.93, and the p-value for voltage and AEM conductivity are 0.00 and 0.26, respectively. The resulting equation is:

$$Resistance ( ohm ) = 8.5365 \times ( Volts ) - 0.054 \times ( AEM Cond . uS / cm ) + 283.9$$

In both Activity I and II, voltage is the controlling parameter with AEM conductivity affecting resistance to a lesser extent.

### Impact of Electrode Separation on Salt Removal

In two of the tests of Activity I, different electrode separations distances were tested. FIG. 22 is a plot of salt removal as a function of energy per 1000 gallons of treated water. The separation distances of 2.5 cm, 3.2 cm, and 4 cm are represented as different colored data points on the chart. The feed chamber sizes were 63.9 mL (Test 1-4), 115.3 mL (Test 1-5), and 166.6 mL (Test 1-6), and all of the tests were conducted at an initial salt concentration of 250 mg/L, NaCl.

The results are compared to Test 1-3. The results suggest slightly lower salt removal for 3.2 cm spacing and even lower removal at 4.0 cm spacing. Interestingly, the effect of reduced salt removal is not as pronounced at higher energy input levels.

### Effect of Exfoliated Graphite on Membrane Chamber Conductivity

In Activity I, Test 1-10 (1-3), the effect of exfoliated graphite on AEC module electrical resistance was evaluated. This was not a part of the original test suite. In this test, both AEM and CEM chambers were packed with exfoliated graphite (EG). PFAS were not analyzed in this test. Performance with regard to salt removal appeared to be similar to testing conducted in Test 1-1-4. Due to the limited data close comparison to the other run was not possible. However, the addition of the EG did not appear to produce a significant change in the AEC overall electrical resistance.

### Operation of AEC on Local Tap Water

A test was conducted where the AEC was operated for seven (7) hours on tap water from Oak Ridge, Tennessee. AEC operating conditions ranged from 17 to 100 VDC, and 50 to 197 mA. The initial feed conductivity was 274 uS/cm. Over the first 5 hours, voltage was maintained at around 44 VDC, with current around 75 mA. Final conductivity held at around 20 uS/cm for about 3.5 hours, after which time it increased to 66 uS/cm. At 3.5 hrs the power was turned off for 5 minutes. No significant reduction in outlet conductivity was observed once power was switched on. At around 4 hours into the test the polarity was reversed for 10 minutes. Immediately upon restoring normal polarity the current increased to 250 mA and then quickly stabilized around 70 mA. There was no significant impact on salt removal performance from polarity reversal, with subsequent outlet conductivity ranging from 55 to 69.3 uS/cm.

Toward the end of the test the voltage was increased to 100 VDC, and the outlet conductivity quickly dropped to 8.5 uS/cm and stabilized near this value.

Upon concluding the test, the AEC module was opened and inspected. The electrodes appeared to be in good condition. A white precipitate was observed at the bottom of the AEC module anode chamber, with a weight of 160 milligrams (mg). The material was pasty and white in color, and did not readily dissolve in acid or base. It was subsequently tested using SEM and found to be titanium dioxide (Refer to Section 5.9). In addition to the residue, it was also found that both the AEM and CEM membranes had migrated into the feed chamber and were resting against the center spacer. It is believed that the increase in outlet conductivity observed over the test was due to the shorter feed chamber residence time caused by the deforming membranes.

The membranes both assumed their original form after soaking in salt water. It has been determined that the use of raised areas on the membranes, as discussed above is effective in preventing contact between the layers due to the distortion. Raised areas such as extruded or adhered lines or spaced dots, preferably covering less than 10%, and preferably less that 8% of the surface area are preferred to address this issue.

This testing shows the likely need for a more durable electrode in the AEM chamber, and the need for reinforcement/support of the membranes. During scale-up care will need to be taken to minimize the potential for membrane deformation. This will include placement of spacers in the flow space or backing material integrated with the membrane.

One run was conducted at a high current of 5 amps (67.6 mA/cm2), which destroyed both membranes.

### AEC Side Chamber Concentration Effects

Over the course of testing some Activity II runs allowed the evaluation of the extent concentration that could be accomplished in a single 3-chamber AEC module.

During operation of the AEC the concurrent hydrolysis of water resulted in the accumulation of hydrogen ion (H+) and chloride (Cl−) ions in the AEM chamber. This resulted in an increase in AEM chamber conductivity proportional to total current input. The pH in the AEM chamber decreased corresponding to the increase in hydrogen ion (H+). In most of the tests the AEM chamber pH dropped to around 2.

As the feed stream is treated, PFAS and salt is transferred out of the feed stream and into the AEM and CEM chambers potentially resulting in a concentration effect. However, the definition of concentration requires further discussion. In dealing with PFAS, a certain fraction will be transferred from the Feed chamber into the AEM chamber. For example, in an AEC operated in the batch mode if 100 ppm PFAS was initially in the feed and 100 percent removed, the entire mass would then be in the AEM chamber. If the AEM chamber was the same size there would be no concentration. However, if the AEM chamber was ½ the volume the PFAS would be concentrated by a factor of 2 times.

In a flow-through system the concentration factor (CF) is calculated as follows:

$$CF = \frac{{F}_{f}}{{F}_{AEM}}$$

Where,
CF=Concentration factor
Ff=Flow Rate of Feed stream
FAEM=Flow rate of AEM stream

In application, if subsequent treatment of the AEM stream is used to remove the PFAS then the concentration factor applies as noted above. However, if the AEM and CEM streams are combined prior to further treatment then the AEM volume or volumetric rate must be added to that corresponding to the AEM chamber, which will reduce the extent of concentration.

During Activity I the AEM and CEM chamber sizes were the same volume so there was no concentration occurring, just transfer of the salt and PFAS from the Feed to the AEM chamber. During Activity II the concentration factor was adjusted by AEM flow rate adjustment.

During Activity II, Test 2-9 was conducted specifically to evaluate performance at a higher side chamber concentration factor. In a pre-test (2-0-13) used to set the conditions for 2-9, the Feed chamber flow was 25 mL/min and the side chambers were both at 0.52 mL/min, for an AEM chamber concentration factor of 48. This test involved operation at 250 mg/L NaCl in the feed, and at an initial 203 uS/cm side chamber conductivity. Throughout the test, electrical current was steadily increased to a final current value of 310 mA, at which point the AEM chamber measured 12,890 uS/cm and the CEM chamber measured 13,790 uS/cm. The highest salt removal was 77.6 percent at 310 mA, and 50 VDC, and at a cell residence time of less than 10 minutes. The extreme pH values were 1.8 (AEM) and 12.6 (CEM). At 95 minutes into the test, at the point of highest salt removal, the current suddenly fell from 310 to 25 mA and stabilized at near that value. The test was halted and the apparatus disassembled and weighed. The anode rinse contained a milky sediment, but the AEM appeared to be in good condition other than slight discoloration in a few locations.

Test 2-9 was conducted at the same operating conditions but at a higher side chamber flow rate of 1 mL/min, for a maximum concentration factor of 35. Table 5-2 presents a comparison of Test 2-8 with Test 2-3 of the MTS. Both were conducted at 35 mL/min feed rate, at 250 mg/L feed salt, and 10 ppb feed PFOA and PFOS. FIG. 5-9 shows removal and associated total current. Test 2-9 showed better overall performance as compared to Test 2-3. Therefore, a CF of between 35 and 48 times appears to be achievable in the AEM chamber.

TABLE 5-2
Comparison of High AEM Total Ion Concentration Run With a
Similar MTS Run

| | | Total | Total | Total | AEM | | | |
|---|---|---|---|---|---|---|---|---|
| | | PFOA + | Current | Energy | Chamber | AEM | | |
| | Salt | PFOS | (A-hr/ | (KW-hr/ | Flow | Chamber | | |
| | Removal | Removal | 1000 | 1000 | (mL/ | Conductivity | Voltage | |
| Run | (%) | (%) | gal. | gal.) | min) | (μS/cm) | (VDC) | CF |
| 2-3-2 | 58.78 | 44.6 | 422.5 | 11.41 | 4 | 2,270 | 27 | 2.8 |
| 2-3-3 | 99.60 | 95.6 | 622.6 | 38.72 | 4 | 2,625 | 62 | 2.8 |
| 2-9-1 | 40.8 | 22.2 | 72.1 | 1.87 | 1 | 2,190 | 26 | 35 |
| 2-9-2 | 83.2 | 62.9 | 135.2 | 7.10 | 1 | 3,340 | 52.5 | 35 |
| 2-9-3 | 97.6 | 91.5 | 180.3 | 23.79 | 1 | 5,570 | 132 | 35 |

### Fate of PFAS

During Activity I testing it was observed that no PFOS or PFOS was found in the concentrate chamber of the AEC. This finding was confirmed in Activity II testing.

Initial analytical activities directed at determining the fate of the PFOA and PFOS removed from the feed chamber included the following:
Analysis of the side chamber liquid (both AEM and CEM) for PFOA and PFOA.
Analysis of AEM membrane HPLC water rinse for PFOA and PFOS.
Analysis of AEM electrode rinse for PFOA and PFOS
Analysis of AEM electrode residue and deposits found in the AEM chamber. These residues were first extracted in methanol, taken to dryness, re-dissolved in HPLC water, and that water recombined with the AEM chamber water for analysis.
During Activity I a sample was collected and analyzed after the feed was placed in the Feed Chamber with no associated current and with no loss in PFOA and PFOS content.

The results of these evaluations are presented in Table 5-3

TABLE 5-3
AEM and CEM Chamber Liquid Analytical Results

| Run #/ | | | PFOA | PFOS |
|---|---|---|---|---|
| Sample | | UTK | Conc. | Conc. |
| ID | Description | Label | (ppb) | (ppb) |
| 2-2-AEM | Test 2-2, Anode Liquid | BL 89 | 0.006 | 0.018 |
| 2-2- | Test 2-2. Anode Rinse + | BL 94 | 0.003 | 0.012 |
| AEM1 | Solids Extract | | | |
| 2-2- | Test 2-2, AEM Rinse | BL 90 | 0.002 | 0.017 |
| AEM2 | | | | |
| 2-8AEM1 | Test 2-8, Anode Liquid | BL 65 | 0.010 | 0.030 |
| 2-8- | Test 2-8, Anode Rinse + | BL 96 | 0.009 | 0.020 |
| AEM2 | Solids Extract | | | |
| 2-8AEM3 | Test 2-8 AEM Rinse | BL 67 | 0.010 | 0.030 |
| 2-9-AEM | Test 2-9, AEM Liquid | BL 91 | 0.002 | 0.018 |
| 2-9- | Test 2-9, Anode Rinse + | BL 92 | 0.007 | 0.019 |
| AEM2 | Solids Extract | | | |
| 2-9-CEM | Test 2-9, CEM Liquid | BL 93 | 0.005 | 0.019 |

Analytical results show no significant PFOA or PFOS in either the AEM or CEM Chambers. Additionally, no significant concentrations of PFOA or PFOS were found in the anode electrode rinse, AEM rinse, or the sediment extract.

Subsequently, a study was undertaken to identify the fate of the two PFAS. This study was not a part of the original test plan. It was suspected that the PFAS was being degraded by oxidation and free radical attack at the anode. A supplemental test was developed to analyze liquid in all chambers, and generated solids.

This testing involved creating a feed sample with a higher concentration of each PFAS (i.e., 1ppm) than was used with the “official” test matrix. This higher PFAS concentration was required to provide the necessary analytical detection of possible PFAS degradation products. Flow-through testing (Test 2-0-16) was conducted at 10.7 mL/m, at 610 to 850 A-hr/1000 gallons, and at 250 mg/L NaCl in the feed stock, producing greater than 99 percent salt removal (99.2 to 99.7 percent).

The samples from Run 2-0-16 were analyzed using a high-resolution Q Exactive (QE) Thermo Scientific Quadrupole-Orbitrap Mass Spectrometer, operated in the negative mode and set for a broad focus (nontargeted) to identify possible degradation products. This is a different instrument than the LC-MS/MS (QQQ) that was used to quantify PFOA and PFOS. Samples analyzed included AEM and CEM Chamber liquid, residue, feed, treated feed, and blank samples. The QE analysis, although non-quantitative, provided the following findings:
The QE analysis further supported the results from Phase I analytical program showing high removal of PFOA and PFOS from the feed stream.
The QE analysis identified a number of other PFAS impurities (low level impurities in the analytical standards) in the feed at lower levels than the PFOA and PFOS (i.e., C6 PFAS acid, C7 PFAS acid, C6 PFAS sulfonic acid, C9 PFAS acid), and all of these showed removals through AEC treatment similar to that of the spiked PFOA and PFOS.
The QE analysis showed no significant levels of PFOA or PFOS in any of the samples analyzed other than the relative expected chromatogram peak area ratios between in the feed inlet and outlet samples.
A large number of unknown features were detected in the QE screen across the sample types indicating the presence of potential breakdown products/pathways, many of which were not seen in the feed exit stream. Due to the high analytical sensitivity of this method, a portion of these features could be organic residues associated with PFAS impurities in the spike sample, PFAS degradation products, butyl rubber decomposition products, and AEM and CEM breakdown products. The AEM sample had the most features detected, including 26 that were only detected in the AEM. The high peak areas of the features identified in the AEM as compared to the other samples could be indicative of breakdown products.

The samples were also analyzed for fluorine, but the results were inconclusive because the samples used had been previously extracted for Method 537 analysis.

Follow-up testing was conducted to obtain more conclusive results. A 1 ppm PFOA and PFOS spike was added to the AEM Chamber feed and the sample train was operated in the same manner as 2-0-16. The sample was submitted to a local laboratory for Fluorine analysis to determine if the PFAS was being mineralized. Additionally, the same test setup was run with 10 ppb of PFOA and PFOS spiked into the AEM Chamber feed. The AEM exit sample was submitted to a commercial laboratory for PFAS analysis (24 compound list, including PFOA and PFOS). These results are not available as of this submittal.

In summary, the above results show that PFOA and PFOS are being chemically modified or decomposed within the AEC.

Comparison of Nafion® 117 membrane and Fumesep® FKA-50 membrane CEM

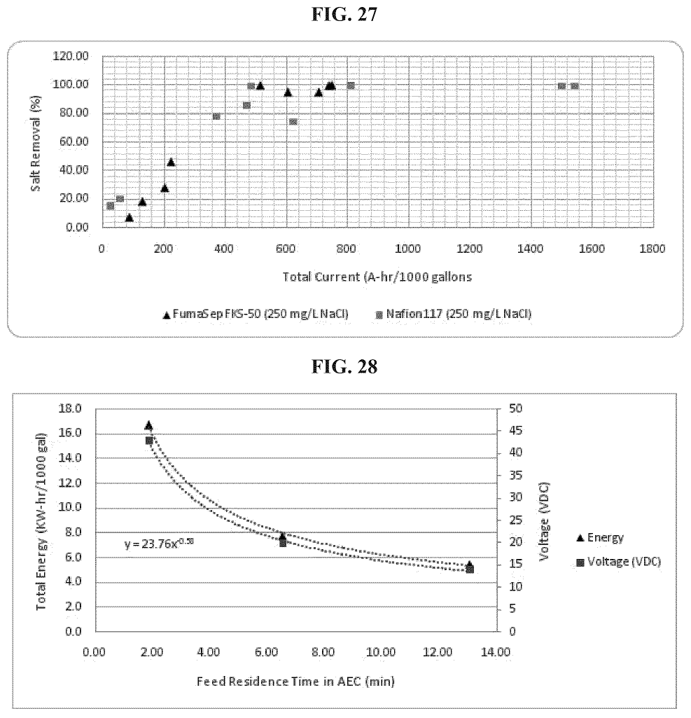

During Activity 1, Test 4, Runs 1-9, Nafion® membrane 117 CEM was used. FIG. 5-10provides a graphical comparison of salt removal performance between Test 4 (Nafion®) and Test 3 (Fumasep® FKS-50). The Nafion® appears to require slightly lower current for a given removal, particularly at currents below 200 A-hr/1000 gallons. However, the results are not consistent throughout the graph in FIG. 27.

### Characterization of AEM Residue

During the testing noticeable residue was observed in the AEM chamber after every test. It was believed that this was most likely titanium dioxide produced from titanium eroded from the electrode. Two samples were submitted for scanning electron microscope (SEM) analysis to ascertain the elemental composition. The results are presented in Table 5-6. Sample 1 represents the dried residue (originally pasty consistency) from Run 2-0-11, and Sample 2 represents residue from test run 2-9.

TABLE 5-6
SEM Analytical Results for AEM Chamber Residue

| Element | Units | Sample 1 | Sample 2 |
|---|---|---|---|
| Titanium | Mass % | 63.6 | 73.3 |
| Chloride | Mass % | 1.6 | 3.0 |
| Fluoride | Mass % | 0.6 | trace |
| Oxygen | Mass % | * | * |

*Oxygen was present as a significant component but not quantified.

The fluoride detected in Sample 1 is likely the result of fluoridation of the water (Oak Ridge, TN tap water used in this test). The fluoride in Sample 2 (DI water source) suggests mineralization of organic fluoride.

### Impact of AEC Residence Time on Performance

Test 2-8 was conducted to evaluate the effect of AEC module liquid feed residence time on performance. In this test the feed was operated at three rates (5, 10, and 35 mL/min). The operating voltage was varied to produce a constant electrical current in each test. All runs were conducted at the same initial feed conductivity of 491 uS/cm. Table 5-7 summarizes the results of the testing.

The results show that at a constant total current, salt removal was reasonably consistent (68.6 to 76 percent), with total PFOA and PFOS removal ranging from 45.2 to 55.7 percent. The energy required was inversely proportional to the square root of the residence time, as shown in FIG. 29, and the required voltage followed the same relationship.

In this test, at flow cross sectional dimensions of 8.525 mm×50.8 mm, or 4.33 cm², the flow rates are shown in Table 5-7 as superficial velocity (through empty area). The actual velocity through the chamber is estimated at 30% greater due to the presence of the feed chamber mesh spacer.

TABLE 5-7
Constant Total Current Test Results (Test 2-8)-Activity II

| | Total | | Superficial | | Total | Energy | | |
|---|---|---|---|---|---|---|---|---|
| | PFAS | Salt | Flow | Retention | Current | (KW-hr/ | | |
| Test | Removal | Removal | Velocity | Time | (A-hr/ | 1000 | Voltage | Current |
| Run | (%) | (%) | (cm/min) | (min) | 1000 gal | gal | (VDC) | (mA) |
| 2-8-1 | 45.2 | 70.67 | 1.15 | 13.1 | 388.6 | 5.4 | 14 | 30.8 |
| 2-8-2 | 42.7 | 68.64 | 2.31 | 6.5 | 386.7 | 7.7 | 20 | 61.3 |
| 2-8-3 | 55.7 | 76.17 | 8.08 | 1.9 | 388.8 | 16.7 | 43 | 215.7 |

### 5.11 Temperature Effects

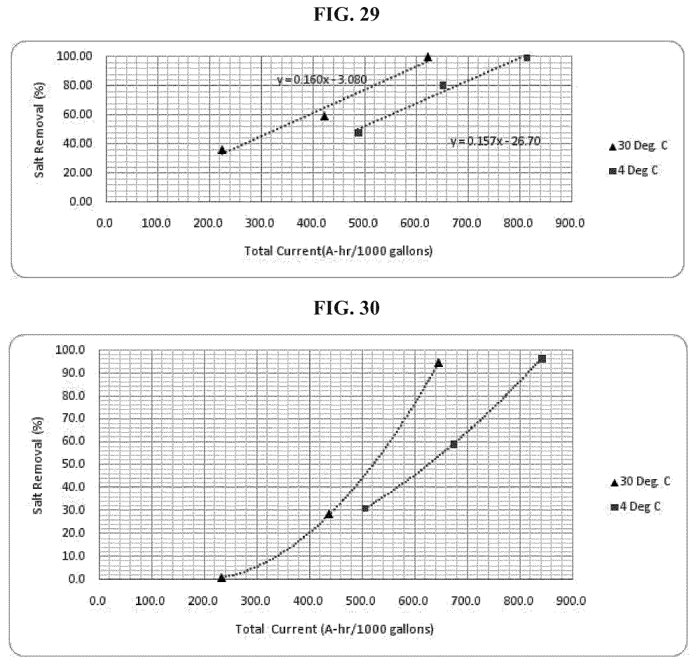

The effect of temperature on the removal of salt and PFOA and PFOS was evaluated in Tests 2-3 and 2-7. These two tests were conducted at the same two operating conditions and with an inlet feed salt concentration of 500 uS/cm. The results for salt are presented in FIG. 30. Equations fitting the results of each test are presented on the figure.

Because the trend lines are parallel, the required test current can be adjusted from a known reference current by subtracting 6.423 amps for every 1° C. temperature increase.

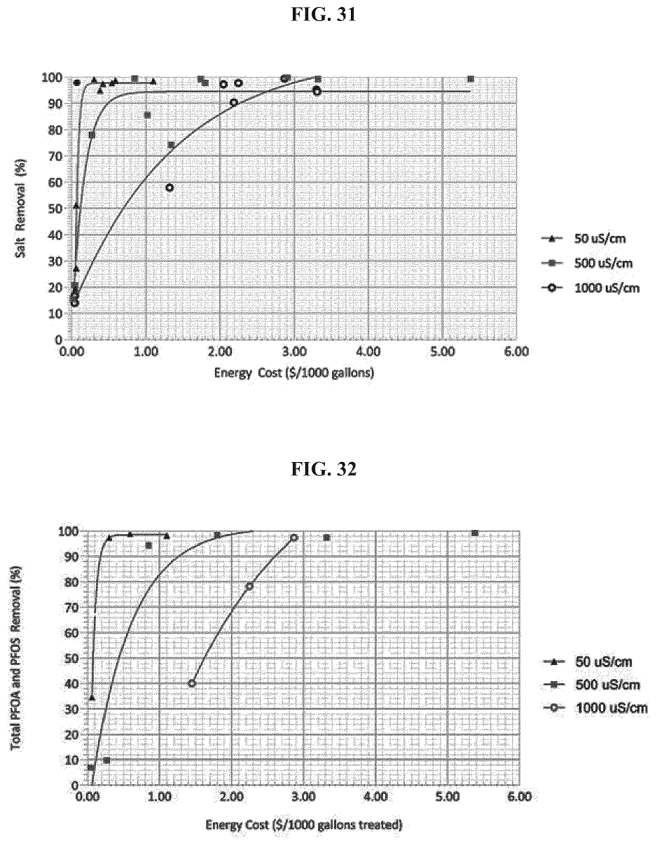

For total PFOA and PFOS evaluation of required current at different temperatures can be accomplished by interpolation from FIG. 31.

### Scale-Up Evaluation

### Economics of Phase I Bench Scale Testing

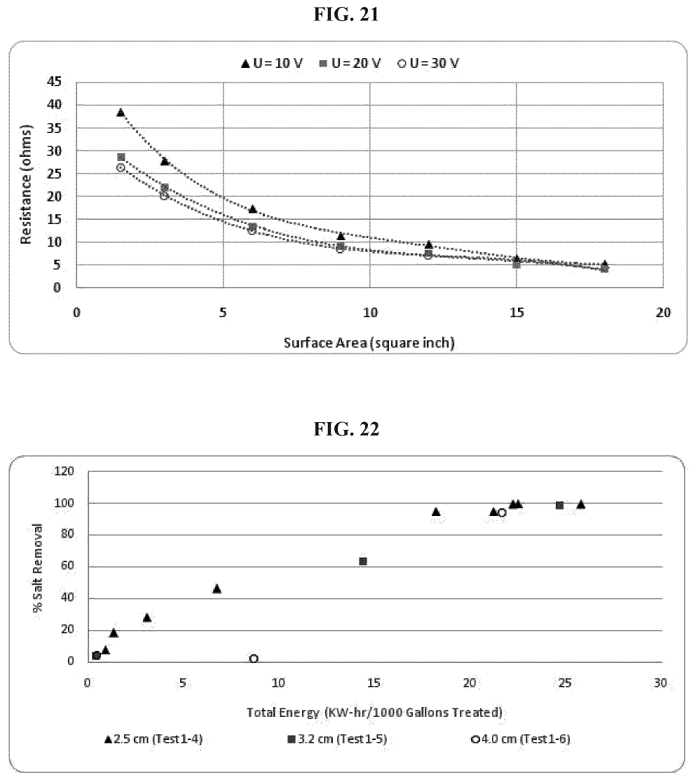

At the bench scale the initial primary indication of the AEC's suitability for commercialization is the cost of electrical power required to remove the PFAS. The bench scale AEC system was designed primarily to demonstrate PFAS removal, without considerable consideration of economic optimization. Some changes that will be made to the next level of AEC development will include modifications to promote better electrical efficiency and operational stability, and considerations previously discussed. These will include considerations including minimizing module thickness and associated internal separation distances. Chamber housings will likely be reduced from 5 mm to between 1-2 mm, with much thinner sealing gasket materials used. Additional electrical efficiency will be gained by incorporating a platinum plated anode, and possibly a gold-plated cathode, and utilizing information from FIG. 21 to minimize overall electrical resistance. For example, as noted in FIG. 21, increasing the module electrode area will result in a 2 times reduction in electrical resistance. Further module resistance reduction will be achieved by maintaining a relatively high side chamber (AEM/CEM) conductivity by increasing the feed to side chamber feed flow rate ratio.

In cost discussion it is important to note that the cost results are for a non-optimized system and should be viewed as order-of-magnitude costs. Due to optimization, electrical costs are expected to be lower in subsequent pilot generations of the AEC.

### Economics of Batch Operation

Energy costs are presented in FIG. 31 (salt removal) and FIG. 32 (PFOA and PFOS removal) for the Activity I batch testing. Energy costs are presented as a function of salt removal. Power cost was estimated at $0.0718/KW-hr based on July 2019 EIA data for industrial energy cost. On close observation the general trend can be observed. This chart shows that power costs are lower for water feed streams with low conductivities, and increase with increasing inlet feed conductivity. For example, at 50 uS/cm feed conductivity, the power cost for 98% salt removal is in the range of $0.40/1000 gallons, and for 500 uS/cm is $1.75. For 1000 uS/cm the same removal appears to fall around $3-4/1000 gallons as shown in FIG. 31.

FIG. 32 shows that energy costs for PFAS removal (initial concentration 100 ppb PFOA and 100 ppb PFOS) are lower when the feed stream conductivity is lower, and increase with increasing feed conductivity. For example, at 50 uS/cm feed conductivity, the cost for 98% PFAS removal is in the range of $0.30/1000 gallons, and for 500 uS/cm is $1.75. For 1000 uS/cm the same removal appears to fall around $3.00/1000 gallons.

### Flow Through Runs

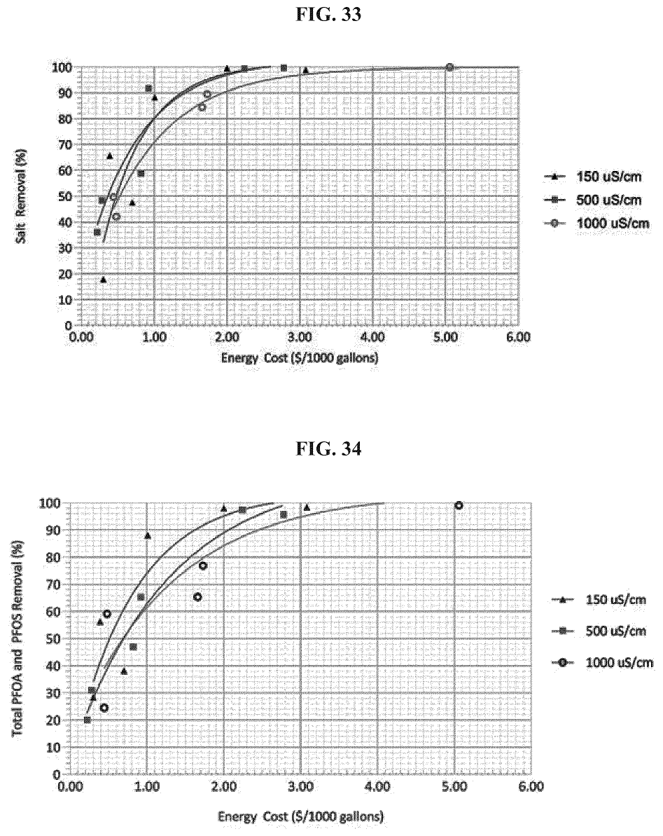

Energy costs for the flow-through AEC operating mode are presented in FIG. 33 (salt removal) and FIG. 35 (PFOA and PFOS removal), with costs presented as a function of percent removal. Energy cost was estimated at $0.0718/KW-hr. On close observation the general trend can be observed. This chart shows that power costs are lower for water feed streams with low conductivities, and increase with increasing feed conductivity. For example, at 150 uS/cm feed conductivity, the cost for 98% conductivity removal is in the range of $2.25/1000 gallons, and for 500 uS/cm is $3.00/1000 gallons. For 1,000 uS/cm the same removal appears to fall around $3.00/1000 gallons.

A semipermeable membrane (SPM) is a barrier that will only allow some molecules to pass through while blocking the passage of other molecules. A semipermeable barrier essentially acts as a filter. Different types of semipermeable membranes can block out different sized molecules. A semipermeable membrane can be made out of biological or synthetic material. The semipermeable membrane is defined by its pore size (to control the size of molecules allowed to pass through the SPM and its oleophilic/hydrophilic and ionic properties. Synthetic membrane can be fabricated from a large number of different materials. It can be made from organic or inorganic materials including solids such as metal or ceramic, homogeneous films (polymers), heterogeneous solids (polymeric mixes, mixed glasses), and liquids. Ceramic membranes are produced from inorganic materials such as aluminum oxides, silicon carbide, and zirconium oxide. Ceramic membranes are very resistant to the action of aggressive media (acids, strong solvents). They are very stable chemically, thermally, and mechanically, and biologically inert. Even though ceramic membranes have a high weight and substantial production costs, they are ecologically friendly and have long working life. Ceramic membranes are generally made as monolithic shapes of tubular capillaries.

### Polymeric Membranes

Polymeric membranes lead the membrane separation industry market because they are very competitive in performance and economics. Many polymers are available, but the choice of membrane polymer is not a trivial task. A polymer has to have appropriate characteristics for the intended application. The polymer sometimes has to offer a low binding affinity for separated molecules (as in the case of biotechnology applications), and has to withstand the harsh cleaning conditions. It has to be compatible with chosen membrane fabrication technology. The polymer has to be a suitable membrane former in terms of its chains rigidity, chain interactions, stereoregularity, and polarity of its functional groups. The polymers can form amorphous and semicrystalline structures (can also have different glass transition temperatures), affecting the membrane performance characteristics. The polymer may be obtainable and reasonably priced to comply with the low-cost criteria of membrane separation process. Many membrane polymers are grafted, custom-modified, or produced as copolymers to improve their properties._{[4]} The most common polymers in membrane synthesis are cellulose acetate, nitrocellulose and cellulose esters. (CN, and CE), polysulfone, polyether sulfone, polyacrylonitrile, polyamide, polyimide, polyalkylene (polyethyelene and polypropylene), polytetrafluoroethylene, polyvinylidenefluoride and polyvinyl chloride, as well as copolymers of these materials. Polymer membranes may be functionalized into ion exchange membranes by the addition of highly acidic or basic functional groups, e.g. sulfonic acid and quaternary ammonium, enabling the membrane to form water channels and selectively transport cations or anions, respectively. The most important functional materials in this category include proton exchange and alkaline anion exchange membranes, that are at the heart of many technologies in water treatment, energy storage, energy generation. Applications within water treatment include reverse osmosis, electrodialysis, and reversed electrodialysis

### Ceramic Membranes

Ceramic membranes are made from inorganic materials (such as alumina, titania, and zirconia oxides, recrystallized silicon carbide or some glassy materials). By contrast with polymeric membranes, they can be used in separations where aggressive media (acids, strong solvents) are present. They also have excellent thermal stability which make them usable in high temperature membrane operations.

Other variations in the practice of the technology can be exercised using the teachings provided herein.

What is claimed:

1. A system for the removal of poly- and/or perfluoroalkyl fluorinated material contaminants from an aqueous mass, wherein the system comprises:
a. a first chamber for holding the aqueous mass containing a detectable amount of poly- and/or perfluoroalkyl fluorinated materials;
b. an anode and a cathode in electronic connection with the aqueous mass in the first chamber; and
c. an anionic poly- and/or perfluoroalkyl fluorinated material contaminant retaining sheet between the aqueous mass and the anode;
wherein the anionic poly- and/or perfluoroalkyl fluorinated material contaminant retaining sheet comprises at least 0.0001% by total weight of the anionic poly- and/or perfluoroalkyl fluorinated material contaminant retaining sheet of a cationic material or a proteinaceous material adhered to the anionic semipermeable membrane.

2. The system of claim 1 further comprising:
a. a cationic poly- and/or perfluoroalkyl fluorinated material contaminant retaining sheet between the aqueous mass and the cathode;
wherein the cationic poly- and/or perfluoroalkyl fluorinated material contaminant retaining sheet comprises at least 0.0001% by total weight of the cationic poly- and/or perfluoroalkyl fluorinated material contaminant retaining sheet of an anionic material adhered to the cationic semipermeable membrane.

3. The system of claim 1 wherein there is a second aqueous mass adjacent the anode and adjacent the anionic poly- and/or perfluoroalkyl fluorinated material contaminant retaining sheet.

4. The system of claim 1 wherein the cationic material comprises a compound having a cation selected from the group consisting of quaternary ammonium cations, sulfonium cations, phosphonium cations, iodonium cations, and boronium cations.

5. The system of claim 3 wherein the anionic poly- and/or perfluoroalkyl fluorinated material contaminant retaining sheet comprises at least 0.001% by total weight of the anionic poly- and/or perfluoroalkyl fluorinated material contaminant retaining sheet of a cationic quaternary ammonium compound adhered to the anionic poly- and/or perfluoroalkyl fluorinated material contaminant retaining sheet.

6. The system of claim 3 wherein the cationic material comprises a polymer.

7. The system of claim 4 wherein the cationic material comprises a polymer.

8. The system of claim 3 wherein the cationic material comprises a quaternary ammonium polymer.

9. The system of claim 4 wherein the cationic material comprises a quaternary ammonium polymer.

10. The system of claim 1 wherein the anionic poly- and/or perfluoroalkyl fluorinated material contaminant retaining sheet has a thickness between 30 μm and 2 mm.

11. The system of claim 2 wherein the anionic semipermeable membrane has a thickness between 30 μm and 2 mm.

12. The system of claim 4 wherein the anionic semipermeable membrane has a thickness between 1 μm and 1 mm.

13. The system of claim 8 wherein the anionic semipermeable membrane has a thickness between 50 μm and 1 mm.

14. The system of claim 1 further comprising a cationic poly- and/or perfluoroalkyl fluorinated material contaminant retaining sheet between the aqueous mass and the cathode.

15. The system of claim 4 further comprising a cationic poly- and/or perfluoroalkyl fluorinated material contaminant retaining sheet between the aqueous mass and the cathode.

16. The system of claim 7 further comprising a cationic poly- and/or perfluoroalkyl fluorinated material contaminant retaining sheet between the aqueous mass and the cathode, and further wherein there is a third aqueous mass adjacent the cathode and adjacent the cathodic semipermeable membrane.

17. The system of claim 15 wherein the cationic poly- and/or perfluoroalkyl fluorinated material contaminant retaining sheet has a thickness between 30 μm and 2 mm.

18. The system of claim 13 wherein there is a spacer within the first chamber to prevent the anodic poly- and/or perfluoroalkyl fluorinated material contaminant retaining sheet and the cationic poly- and/or perfluoroalkyl fluorinated material contaminant retaining sheet from collapsing into the first chamber.

19. A method for extracting poly- and/or perfluoroalkyl fluorinated materials from an aqueous medium comprising:
a) providing an aqueous medium contaminated with measurable levels of poly- and/or perfluoroalkyl fluorinated materials within a chamber;
b) providing an opposed anode and cathode configured to support a current across the chamber;
c) positioning an anionic poly- and/or perfluoroalkyl fluorinated material contaminant retaining sheet between the anode and cathode;
d) applying a current between the anode and cathode to attract the poly- and/or perfluoroalkyl fluorinated materials towards the anode and onto the anionic semipermeable membrane; and
e) the anionic poly- and/or perfluoroalkyl fluorinated material contaminant retaining sheet retaining poly- and/or perfluoroalkyl fluorinated materials;
wherein the anionic poly- and/or perfluoroalkyl fluorinated material contaminant retaining sheet comprises at least 0.0005% by total weight of the anionic poly- and/or perfluoroalkyl fluorinated material contaminant retaining sheet of a cationic compound or proteinaceous material adhered to the anionic poly- and/or perfluoroalkyl fluorinated material contaminant retaining sheet.

20. The method of claim 18 wherein the anionic poly- and/or perfluoroalkyl fluorinated material contaminant retaining sheet abuts the anode and maintains a second aqueous liquid between the anode and the anionic poly- and/or perfluoroalkyl fluorinated material contaminant retaining sheet.

21. The method of claim 19 wherein the second aqueous liquid is substantially free of poly- and/or perfluoroalkyl fluorinated materials.

22. The method of claim 19 wherein a cationic poly- and/or perfluoroalkyl fluorinated material contaminant retaining sheet abuts the cathode and maintains a third aqueous liquid between the cathode and the cationic poly- and/or perfluoroalkyl fluorinated material contaminant retaining sheet.

23. A system for the removal of poly- and/or perfluoroalkyl fluorinated material contaminants from an aqueous mass, wherein the system comprises:
a. a first chamber for holding the aqueous mass containing a detectable amount of poly- and/or perfluoroalkyl fluorinated materials;
b. an anode and a cathode in electronic connection with the aqueous mass in the first chamber; and
c. an anionic poly- and/or perfluoroalkyl fluorinated material contaminant retaining sheet between the aqueous mass and the anode;
wherein the anionic poly- and/or perfluoroalkyl fluorinated material contaminant retaining sheet comprises at least 0.0001% by total weight of the anionic poly- and/or perfluoroalkyl fluorinated material contaminant retaining sheet of a cationic material or a proteinaceous material adhered to the anionic semipermeable membrane.

24. The system of claim 22 further comprising:
a. a cationic poly- and/or perfluoroalkyl fluorinated material contaminant retaining sheet between the aqueous mass and the cathode;
wherein the cationic poly- and/or perfluoroalkyl fluorinated material contaminant retaining sheet comprises at least 0.0001% by total weight of the cationic poly- and/or perfluoroalkyl fluorinated material contaminant retaining sheet of an anionic material adhered to the cationic semipermeable membrane.
